(19) United States
(12) Patent Application Publication
(10) Pub. No.: US 2014/0156474 A1
(43) Pub. Date: Jun. 5, 2014

(54) METHOD OF FORECASTING A RESIDUAL VALUE OF A VEHICLE

(71) Applicant: Chrome Capital Group Inc., Naples, FL (US)

(72) Inventors: Stephen J. Swain, Naples, FL (US); Peter E. Wasmer, Naples, FL (US); Brian David Cramer, Middletown, DE (US)

(21) Appl. No.: 14/094,342

(22) Filed: Dec. 2, 2013

Related U.S. Application Data
(60) Provisional application No. 61/731,945, filed on Nov. 30, 2012.

(51) Int. Cl. G06Q 40/00

(52) U.S. Cl. CPC G06Q 40/12
USPC 705/30

(57) ABSTRACT

A method for forecasting a residual value of a first vehicle having existent and nonexistent model years is disclosed. Part of the method includes creating a proxy vehicle form a selected one of a plurality of second vehicles for each nonexistent model year within a predetermined time frame with the proxy vehicle having a proxy vehicle identifier, populating an initial database with the proxy vehicle identifier for each nonexistent model year to create a comprehensive database, and converting the proxy vehicle identifier for each first existent model year into a monetary value, and utilizing a processor to calculate the residual value of the first vehicle utilizing the monetary value of the proxy vehicle.

### CROSS REFERENCE TO RELATED APPLICATION

The subject application claims priority to and all of the benefits of U.S. Provisional Application Ser. No. 61/731,945, filed on Nov. 30, 2012, the disclosure of which is incorporated herein by reference in its entirety.

### FIELD OF THE DISCLOSURE

The present disclosure relates generally to lease payment methods and systems, and more particularly, to a method for forecasting a residual value of a vehicle.

### BACKGROUND

The residual value of a vehicle is typically a measure of the depreciation of the vehicle over a period of time, and is often used for determining lease payments of the vehicle. The determination of the lease payments typically utilizes historical wholesale value data of earlier models of the vehicle. In some instances, however, the historical wholesale value data of the earlier models of the vehicle may be unavailable. It may therefore be difficult to accurately calculate the residual value of the vehicle.

### SUMMARY

A method of forecasting a residual value of a first vehicle is disclosed. The first vehicle has first existent model years and first nonexistent model years with the first existent model years and the first nonexistent model years falling within a predetermined time frame. The first vehicle further has a first set of attributes and a first vehicle identifier. The method utilizes a plurality of second vehicles having second existent model years and second nonexistent model years with each of the second vehicles having a unique vehicle identifier. One or more steps of the method are implemented by a processor having a non-transitory computer-readable storage medium with an executable application stored thereon. The method comprises the steps of populating a database with the first vehicle identifier for each of the first existent model years and the unique vehicle identifier of each of the second vehicles for each of the second existent model years to define an initial database without a vehicle identifier for each of the first and second nonexistent model years, determining a second set of attributes for each of the second vehicles, comparing the first set of attributes with the second sets of attributes, selecting one of the plurality of second vehicles for each nonexistent model year of the first vehicle within the predetermined time frame with the selected one of the plurality of second vehicles having attributes from the second sets of attributes that are common with attributes from the first set of attributes, creating a proxy vehicle from the selected one of the second vehicles for each nonexistent model year of the first vehicle within the predetermined time frame with the proxy vehicle having a proxy vehicle identifier, populating the initial database with the proxy vehicle identifier for each nonexistent model year of the first vehicle to create a comprehensive database, converting the proxy vehicle identifier for each nonexistent model year into a monetary value, and utilizing the processor to calculate the residual value of the first vehicle utilizing the monetary value of the proxy vehicle.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a flow diagram depicting an example of a method for forecasting a residual value of a first vehicle.

FIG. 2 is an example of a portion of a table including a column listing a vehicle identifier for several different vehicles and a column for each of the years 2003 to 2012.

FIG. 3 is an example of a portion of an initial database comprising the table of FIG. 2 populated with a vehicle identifier for each existent model year of the several different vehicles and no vehicle identifier for each nonexistent model year of the several different vehicles.

FIG. 4 is an example of portion of a comprehensive database comprising the initial database of FIG. 3 populated with a proxy vehicle identifier for nonexistent model years of the first vehicle.

FIG. 5 is an example of a portion of another comprehensive database comprising the initial database of FIG. 3 populated with a proxy vehicle identifier for nonexistent model years for several different vehicles.

FIG. 6 is an example of a portion of a retail value database comprising the comprehensive database of FIG. 5 with all of the vehicle identifiers converted into a manufacturer-suggested retail price (MSRP) for each vehicle model from the years 2003 to 2012.

FIG. 7 is an example of a portion of a database comprising MSRP, average retail value, and rough trade-in values presently, for 1 year in a lease period, 2 years in a lease period, and 3 years in a lease period.

FIG. 8 is a flow diagram depicting an example of a method for determining a lease payment of a vehicle.

FIG. 9 is schematically illustrates an example of a system for determining a lease payment of a vehicle.

FIGS. 10A through 10F are tables of an example of a spreadsheet illustrating a calculation of a monthly lease payment of the first vehicle according to an example of the present disclosure.

FIG. 11 is a screen shot of “My Profile” page of a webpage driven by a web-based application for determining a monthly lease payment of the first vehicle.

FIG. 12 is a screen shot of a “Dealer Resources” page of the web-page driven by the web-based application.

FIG. 13 is a screen shot of a “Add Child Login for Dealer” page of the web-page driven by the web-based application.

FIG. 14 is a screen shot of a “Dealer Calculator” page of the web-page driven by the web-based application.

FIG. 15 is a screen shot of a page of the web-page driven by the web-based application for calculating the gross capitalized cost of the vehicle.

FIG. 16 is a screen shot of a page of the web-page driven by the web-based application for calculating the capitalized cost reduction of the vehicle.

FIG. 17 is a screen shot of a page of the web-page driven by the web-based application for calculating an amount of money to be paid for the vehicle at signing.

FIG. 18 is a screen shot of a page of the web-page driven by the web-based application for calculating the minimum down payment, the monthly payment, and the amount to be remitted to the dealer.

FIG. 19 is a screen shot of a page of the web-page driven by the web-based application for calculating the gross capitalized cost of the vehicle for calculating the adjusted capital cost of the vehicle.

FIG. 20 is a screen shot of a page of the web-page driven by the web-based application of for calculating the gross capitalized cost of the vehicle for calculating the cash to be paid at signing and the amount of cash to be remitted to the dealer.

### DETAILED DESCRIPTION

The method of the present disclosure may be used to accurately and efficiently calculate, estimate, or otherwise determine a residual value of a first vehicle. The first vehicle is a vehicle to be leased, and is typically a used vehicle. It is to be appreciated, however, that the first vehicle can be a new vehicle. Furthermore, the method of the present disclosure is particularly useful in instances where the manufacturer suggested retail price (MSRP), the current retail price, and/or the wholesale price of the first vehicle for one or more previous years is/are unavailable. This may be due, at least in part, to the first vehicle being nonexistent during the one or more previous years. For instance, the first vehicle may have been introduced in 2005, and thus the vehicle would be nonexistent in 2004, 2003, and any other previous year. Accordingly, the MSRP, the current retail price, and/or the wholesale price of the first vehicle is/are unavailable in 2004, 2003, and so on.

In the method of the present disclosure, a proxy vehicle is created for one or more of the nonexistent first vehicles within a predetermined time frame. The proxy vehicle is a real vehicle that is selected from a plurality of second vehicles, and is used as a surrogate for the nonexistent first vehicle(s). Since the proxy vehicle is being used as a surrogate for nonexistent versions of the first vehicle, it is believed that the wholesale value data of the proxy vehicle may be used to accurately calculate the residual value of the first vehicle.

Details of the method for calculating a residual value of the first vehicle will now be described with reference to the Figures, wherein like numerals indicate like or corresponding parts throughout the several views. In the method, and as previously mentioned, the term “first vehicle” is used to describe a vehicle to be leased. The first vehicle may be a new vehicle or a used vehicle, and is a member of a first family of vehicles. For instance, the first vehicle may Harley-Davidson® Road King®, which is a member of the Harley-Davison® family of Touring motorcycles.

Additionally, the first vehicle (i.e., the vehicle to be leased) has a first vehicle identifier, which may include words, characters, and/or numbers used to identify the first vehicle. The first vehicle identifier may, for instance, be a vehicle identification number (VIN) of the first vehicle, a model number of the first vehicle, or a custom identifier. For example, the model number XL883C may be used as the first vehicle identifier for a Harley-Davidson® Sportster® XL883C. Additionally, the first vehicle has a first set of attributes. In an example, the attributes of the first set of attributes are specific features and/or characteristics of the first vehicle, such as physical characteristics of the first vehicle (such as vehicle color, wheels, lighting, seats, engine design, etc.), historical retail value data (such as the manufacturer suggested retail value (MSRP) of the first vehicle for existent model years), a popularity of the first vehicle (which may be determined by the number of vehicles sold and/or leased), availability of the first vehicle (which may be determined by the number of vehicles presently available for sale and/or lease), and/or promotional characteristics of the first vehicle. The attributes may include one or more of a single type of attribute (such as one or more physical characteristics of the first vehicle) or one or more attributes from one or more types of attributes (such as one or more of physical characteristics, historical retail value data, popularity of the first vehicle, etc.).

The first vehicle further has first existent model years and first nonexistent model years. The term “first existent model year” is used to describe a year that the first vehicle existed. For instance, between the years 2005 through 2012, the Harley-Davidson® Sportster® XL883C existed during the years 2005, 2006, 2007, 2008, and 2009. Accordingly, the first existent model years of the Harley-Davidson® Sportster® XL883C between the years 2005 and 2012 include the years 2005, 2006, 2007, 2008, and 2009. The term “first nonexistent model year”, on the other hand, is used to describe a year that the first vehicle was nonexistent. For instance, between the years of 2005 and 2012, the Harley-Davidson® Sportster® XL883C model did not exist during the years 2010, 2011, and 2012. Accordingly, the first nonexistent model years of the Harley-Davidson® Sportster® XL883C include the years 2010, 2011, and 2012.

It is to be appreciated that the first existent model years and the first nonexistent model years for calculating a residual value of the first vehicle typically fall within a predetermined time frame. The term “predetermined time frame” is used to describe a bounded amount of time (such as a particular number of years) during which MSRP data of the first vehicle is used for calculating the residual value of the first vehicle for a particular lease term. In an example, the predetermined time frame is determined by identifying a lease term of the vehicle, and selecting a number of years prior to the year of manufacture of the vehicle and a number of years subsequent to the year of manufacture of the vehicle up to the end of the lease term. For example, the predetermined time frame for a three (3) year lease of a 2009 Harley-Davidson® Sportster® XL883C with the lease period starting in 2013 may include the years 2006 to 2016 (i.e., a total amount of 11 years). In this example, MSRP and wholesale value data of the Harley-Davidson® Sportster® XL883C and/or proxy vehicles is used for each of the years 2006, 2007, and 2008 for calculating the residual value of the 2009 Harley-Davidson® Sportster® XL883C in 2014, 2015, and 2016, respectively. In this example, a gap in time exists between the years 2009 and 2013. In another example, the predetermined time frame of a two-year lease of a 2009 Harley-Davidson® Sportster® XL883C with a lease period starting in 2013 may include the years 2007 to 2011 (i.e., a total amount of 5 years). In this example, MSRP and wholesale value data of the Harley-Davidson® Sportster® XL883C and/or proxy vehicles for the years 2007 and 2008 is/are used for calculating the residual value of the 2009 Harley-Davidson® Sportster® XL883C in 2014 and 2015, respectively. While 2-year and 3-years leases have been described above, it is to be understood that any lease term may be used in the practice of the present method. Examples of lease terms or lease periods include 1-year leases, 2-year leases, 3-year leases, 4-year leases, and so on. It is to be understood that the lease term is not limited to years, and may also be expressed in terms of other time durations, such as weeks, months, a particular group of days (such as 30 days, 60 days, 80 days, etc.), or even a percent of years. It is further to be understood that the predetermined time frame typically adjusts based on the term of the lease. For instance, a 1-year lease may require a predetermined time frame of 2 years while a 5-year lease may require a predetermined time frame of 6 years. It is to be understood that any number of prior years may be used to calculate the residual value regardless of the lease term. For instance, for a 3 year lease, three prior years or more than three prior years may be used in the residual value calculation.

The method further utilizes a plurality of second vehicles having second existent model years and second nonexistent model years. The term “second vehicle” is used to describe any vehicle other than the vehicle to be leased. Accordingly, the “plurality of second vehicles” includes a number of vehicles other than the vehicle to be leased. Utilizing a 2009 Harley-Davidson® Sportster® XL883C as the first vehicle, the plurality of second vehicles may include, for example, any motorcycle other than a 2009 Harley-Davidson® Sportster® XL883C. In another example, and utilizing a 2009 Harley-Davidson® Sportster® XL883C as the first vehicle, the plurality of second vehicles may include any Harley-Davidson® motorcycle. In yet another example, the second vehicle may be a member of the same family of vehicles as the first vehicle. For instance, the first vehicle may be a Harley-Davidson® Road King® which is a member of the Harley-Davison® family of Touring motorcycles, and the plurality of second vehicles may be any motorcycle falling within the Harley-Davison® family of Touring motorcycles such as a Harley-Davidson® Street Glide®, a Harley-Davidson® Electra Glide® Special, etc. In still another example, the second vehicle may be a member of a second family of vehicles that is financially or physically related to the first family of vehicles. For instance, the first vehicle may be a Harley-Davidson® Road King® which again is a member of the Harley-Davidson® family of Touring motorcycles, and the plurality of second vehicles may include a Harley-Davidson® Night Rod® Special which is a member of the Harley-Davidson® family of V-Rod® motorcycles, a Harley-Davidson® V-Rod Muscle® which is also a member of the Harley-Davidson® family of V-Rod® motorcycles, and a Harley-Davidson® Street Glide® motorcycle which is a member of the Harley-Davidson® family of Touring motorcycles. All of the second vehicles are financially comparable motorcycles to the first vehicle, i.e., the Harley-Davidson® Road King®. In another instance, the first vehicle may be a Harley-Davidson® Fat Bob® which is a member of the Harley-Davidson® family of Dyna® motorcycles, and the second vehicles may include Harley-Davidson® Fat Boy® motorcycles which are members of the Harley-Davidson® Softail® motorcycles that are physically comparable (such as in terms color, engine design, valve train, fuel tank, drive train specifications, etc.) to the Harley-Davidson® Fat Bob® motorcycle.

Additionally, each of the second vehicles has a unique vehicle identifier, which may include words, characters, and/or numbers used to identify a particular second vehicle. The unique vehicle identifier may, for instance, be a vehicle identification number (VIN) of the particular second vehicle, a model number of the particular second vehicle, or a custom identifier. Additionally, each of the second vehicles has second existent model years and second nonexistent model years. The term “second existent model year” may be used to describe a year that a particular second vehicle existed, while the term “second nonexistent model year” may be used to describe a year that the particular second vehicle was nonexistent.

Furthermore, the term “vehicle” may be used to describe any device designed to transport objects and/or living beings (such as people and animals). Examples of vehicles include automobiles, motorcycles, motorbikes, all-terrain vehicles (ATVs), watercraft (such as boats and jet skis), snowmobiles, aircraft (such as airplanes and helicopters), and/or the like. While the method is described herein for calculating a residual value of a vehicle, the method may be applied for calculating a residual value of other objects, devices, and/or apparatuses. For instance, the method may be used to calculate a residual value of equipment, such as business equipment, manufacturing equipment, computer equipment, appliances, and/or the like.

As previously mentioned, the method may be used to calculate the residual value of any vehicle. It is to be appreciated, however, that the method is useful for calculating the residual value of a vehicle which does not change significantly from a vehicle model in a given year to a vehicle model in the next year. Accordingly, the method may be useful for calculating the residual value of motorcycles, jet skis, snowmobiles, and/or the like. For purposes of illustration, the method is described below for calculating the residual value of a Harley-Davidson® motorcycle.

Further, the term “residual value” is used to describe a calculated, estimated, or determined value of the vehicle at the end of a lease. In an example, the residual value is a calculated, estimated, or determined wholesale or “rough” value of the vehicle at the end of the lease.

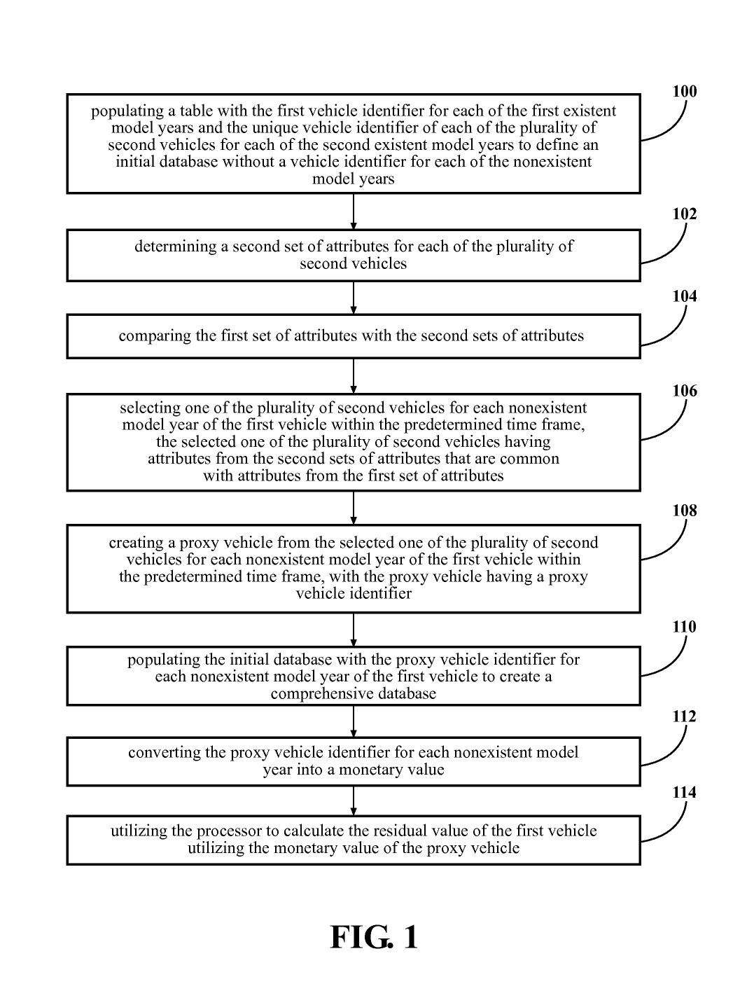

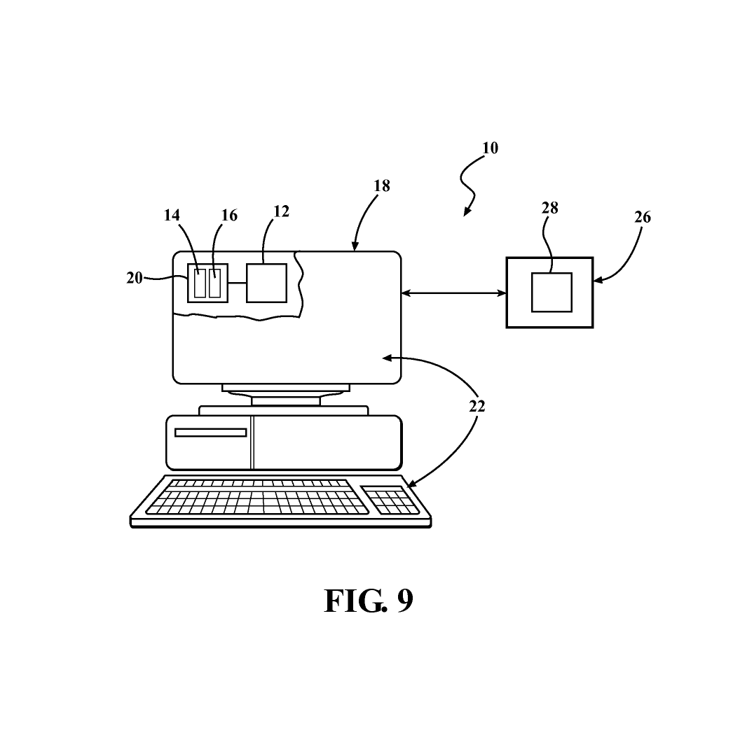

An example of the method for calculating the residual value of the first vehicle will now be described in detail with reference to FIGS. 1-7 and 9. It is to be understood that one or more steps of this method may be implemented by a processor 12 having a non-transitory computer-readable storage medium 20 with an executable application 14, 16 stored thereon. With reference to a system 10 depicted in FIG. 9, the processor 12 may be any computing device, controller, microprocessor, microcontroller, application specific integrated circuit (ASIC) or other device capable of performing numerical calculations and executing applications (e.g. software programs) 14, 16. In an example, the processor 12 may run on an operating system of a computer 18, such as a personal computer (PC), a laptop computer, a tablet computer (such as an iPad®), a smartphone (such as an iPhone®), and/or the like. The computer 18 typically includes a user interface 22, such as a computer monitor and a keyboard, a touch screen, or other suitable user interface. Typically, the application 14, 16 is stored in the storage medium 20 that is operatively connected and/or in communication with the processor 12. Additionally, all of the databases (such as the initial database 202, the comprehensive databases 210, 212, the MSRP database 214, etc.) are also stored in the storage medium 20.

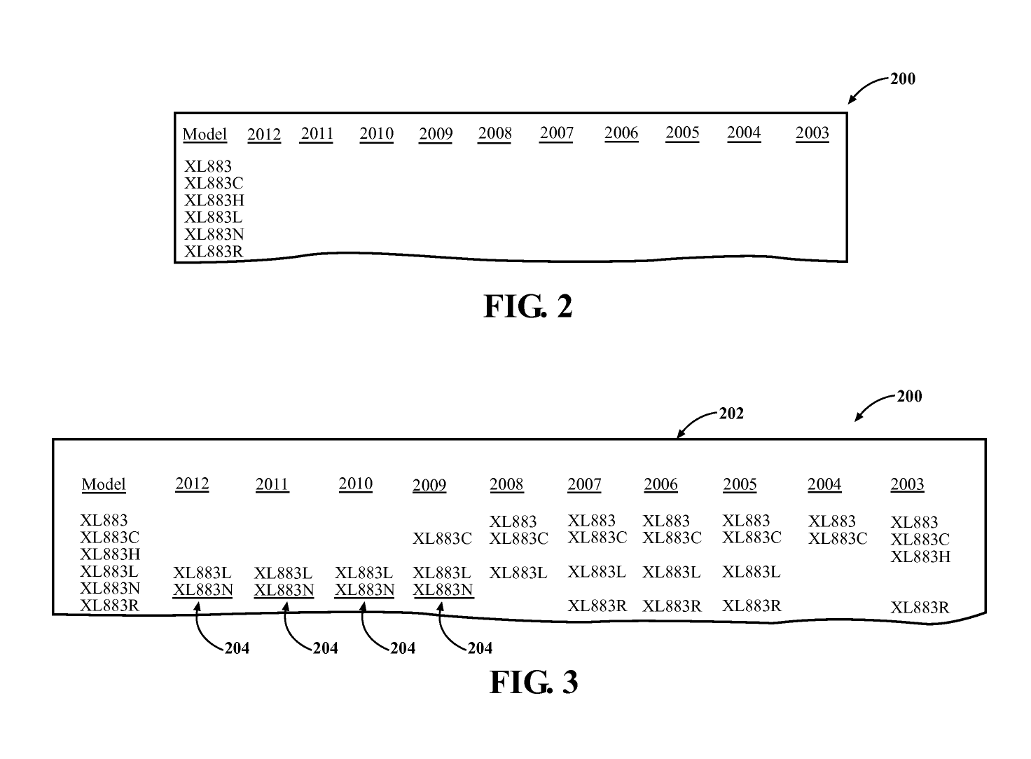

Referring now to FIGS. 1-3, the method for calculating the residual value of the first vehicle comprises the step of populating a table 200 (depicted in FIG. 2) with the first vehicle identifier 204 for each of the first existent model years and the unique vehicle identifier 206 for each of the plurality of second vehicles for each of the second existent model years to define an initial database 202 (a portion of which is depicted in FIG. 3) without a vehicle identifier for each of the nonexistent model years. The step of populating is identified in FIG. 1 by reference numeral 100. In an example, the table 200 depicted in FIG. 2 comprises a plurality of vehicles identified by a vehicle identifier, which in this example is a vehicle model number (such as XL883, XL883C, XL883H, XL883L, XL883N, and XL883R). Table 200 further comprises a number of columns representing model year (such as 2003, 2004, 2005, 2006, 2007, 2008, 2009, 2010, 2011, and 2012).

As shown in FIG. 3, the initial database 202 includes the table 200 populated with a first vehicle identifier 204 (which is shown in underlined font) for each existent model year of the first vehicle. In the example shown, the first vehicle has the first vehicle identifier 204 of XL883N. Also in the example shown, the first vehicle 204 is introduced in the year 2009, and has existent model years of 2009, 2010, 2011, and 2012.

Table 200 is further populated with a unique vehicle identifier 206 for a plurality of second vehicles. In this example, the plurality of second vehicles has the unique vehicle identifiers 206 of XL883, XL883C, XL883H, XL883L, and XL883R. The unique vehicle identifier 206 is incorporated into the table 200 for each second existent model year of the second vehicles. For instance, the second vehicle with the unique vehicle identifier 206 of XL883 existed in the years 2003, 2004, 2005, 2006, 2007, and 2008. Accordingly, the table 200 is populated with the unique vehicle identifier 206 of XL883 for each of the years 2003, 2004, 2005, 2006, 2007, and 2008. In another instance, the second vehicle with the unique vehicle identifier 206 of XR1200X existed in the years 2011 and 2012. Accordingly, the table 200 is populated with the unique vehicle identifier 206 of XR1200X for the years 2011 and 2012.

Additionally, the table 200 does not include a vehicle identifier for any of the first and second nonexistent model years. This is because the first and second vehicles did not exist during the first and second nonexistent model years. Accordingly, and as shown in FIG. 3, no vehicle identifier is present for any of the first and second nonexistent model years in the table 200. Said differently, each of the first and second nonexistent model years in the table 200 in FIG. 3 is blank.

Referring again to FIG. 1, the method further comprises determining a second set of attributes for each of the plurality of second vehicles. The step of determining the second set of attributes is identified by reference numeral 102 in FIG. 1. In the initial database 202 set forth in FIG. 3, there are nineteen (19) second vehicles, and each of the second vehicles has a unique second set of attributes. For instance, the second vehicle with the unique vehicle identifier 206 of XL883 will have its own unique second set of attributes, the second vehicle with the unique vehicle identifier 206 of XL883C will also have its own unique second set of attributes, and so on. It is to be understood that the unique second set of attributes for one of the second vehicles (such as for XL883) may be the same, similar, or different from the unique second set of attributes for another of the second vehicles (such as for XL883C). In an example, the second set of attributes are specific features and/or characteristics of the second vehicle, such as physical characteristics of the second vehicle, historical retail value data of the second vehicle, a popularity of the second vehicle, an availability of the second vehicle, and/or promotional characteristics of the second vehicle. The attributes of the second set of attributes may include one or more of a single type of attribute (such as one or more physical characteristics of the second vehicle) or one or more attributes for one or more different types of attributes (such as one or more of physical characteristics, historical retail value data, popularity of the second vehicle, etc.).

The step of determining the second set of attributes for each of the second vehicles comprises, for example, determining the physical characteristics of each of the second vehicles. This may be accomplished by analyzing the physicality of each of the second vehicles by visually inspecting the second vehicles and/or reviewing a specification sheet of the second vehicles. The step of determining the second set of attributes may also comprise, for example, obtaining the historical retail value data of the second vehicles. This may be accomplished by retrieving a manufacturer suggested retail price (MSRP) of the second vehicle from a vehicle pricing guide, such as a National Association of Automotive Dealers (NADA) guide. If retrieved from the NADA guide, the MSRP may be referred to a NADA retail value of the vehicle. Additionally, the MSRP or NADA retail value may also be referred to as the market value of the vehicle. The step of determining the second set of attributes may also comprise determining a popularity of the second vehicles. This may be accomplished, for instance, by comparing the unit sales of one vehicle model to another vehicle model. The step of determining the second set of attributes may further comprise determining an availability of the second vehicles. This may be accomplished by determining a number of a particular second vehicle that is available for lease, such as by determining a number of the particular second vehicle that is physically present at a particular dealership, is physically present in a particular geographic area (such as a particular city, town, village, etc.), is physically present in a particular state, or is physically present in the country. In instances where there are a number of particular second vehicles that is physically present at the dealership, the particular second vehicle is considered to be available for purposes of determining the second set of attributes. However, in instances where none or just a few (e.g. two or three vehicles) of the particular second vehicles are available in the state or in the country, then the particular vehicle is considered to be unavailable. A determination of the availability of a particular second vehicle also takes into account the number of the particular vehicles that were actually made or manufactured. For instance, the particular second vehicle may be a limited edition, where a limited number of vehicles were made. In this instance, the particular second vehicle may be considered to be unavailable.

As depicted in FIG. 1, the method further comprises the step of comparing the first set of attributes with the second set of attributes, and this step is identified by reference numeral 104 in FIG. 1. The method further comprises selecting one of the plurality of second vehicles for each nonexistent model year of the first vehicle within the predetermined time frame, where the selected one of the plurality of second vehicles have attributes from the second sets of attributes that are common with attributes from the first set of attributes, and this step is identified by reference numeral 106 in FIG. 1. In an example, the step of comparing may be accomplished by identifying similarities and/or differences between the first set of attributes and the second set of attributes. The step of selecting may be accomplished by choosing one of the second vehicles that have attributes from the second set of attributes that are common with (such as similar to or match up with) attributes from the first set of attributes. For instance, the first vehicle may be a Harley-Davidson® Superlow® motorcycle and the second vehicle may be a Harley-Davidson® Iron 883™ motorcycle. By visual inspection, each of these vehicles exhibit common physical characteristics including a low-riding seat, color, length, height, wheel size, and a V-twin engine with a 4-stroke combustion cycle. The Harley-Davidson® Superlow® motorcycle and the Harley-Davidson® Iron 883™ motorcycle also have a comparable MSRPs, and standard models (i.e., models that are not customized) are readily available. Accordingly, the Harley-Davidson® Iron 883™ motorcycle (i.e., the first vehicle) includes several attributes that are common with attributes of the Harley-Davidson® Superlow® motorcycle (i.e., the second vehicle).

It is to be understood that the comparing step is performed for each second vehicle. Based on the results of the comparing step, the selecting step is accomplished by selecting one of the second vehicles which includes attributes that are common with attributes of the selected one of the second vehicles. In an example, the selecting step is accomplished by analyzing the results of the comparison, and choosing a particular vehicle where a majority of the attributes of the first vehicle match the attributes of the second vehicle. In another example, the second vehicle may be selected based on one or a few common attributes while giving greater weight to certain attributes in order to select the most appropriate second vehicle. For instance, historical retail value data may be weighted more heavily than physical attributes, and physical attributes may be weighted more heavily than popularity attributes, etc.

In an example, during the comparing step, the method may comprise identifying the first vehicle as being a member of a first family of vehicles, and narrowing the plurality of second vehicles to the second vehicles that fall within one of the first family of vehicles or a second family of vehicles that is financially or physically related to the first family of vehicles. For instance, if the first vehicle is a member of the Harley-Davidson® family of Touring motorcycles, then the plurality of second vehicles may be narrowed so that the second vehicles are members of the Harley-Davidson® family of Touring motorcycles or are members of a family of Harley-Davidson® motorcycles that is financially or physically related to the Harley-Davidson® family of Touring motorcycles. Examples of narrowing the plurality of second vehicles are described earlier in this disclosure.

The comparing and selecting steps have been described above as being performed manually; however, it is contemplated that the comparing and selecting steps may also be performed utilizing an automated process. For instance, the first set of attributes and the second set of attributes may be inputted as data into an application (not shown) that is executable by the processor 12. The application may include computer-readable instructions for comparing the data, and for selecting one of the second vehicles based on the comparison.

The method further comprises the step of creating a proxy vehicle from the selected one of the plurality of second vehicles for each nonexistent model year of the first vehicle within the predetermined time frame, with the proxy vehicle having a proxy vehicle identifier 208. The creating step is identified by reference numeral 108 in FIG. 1. It is to be understood that the proxy vehicle is the selected one of the plurality of second vehicles, and the proxy vehicle identifier 208 may include words, characters, and/or numbers used to identify the proxy vehicle. The proxy vehicle identifier 208 may be a vehicle identification number (VIN) of the proxy vehicle, a model number of the proxy vehicle, or a custom identifier.

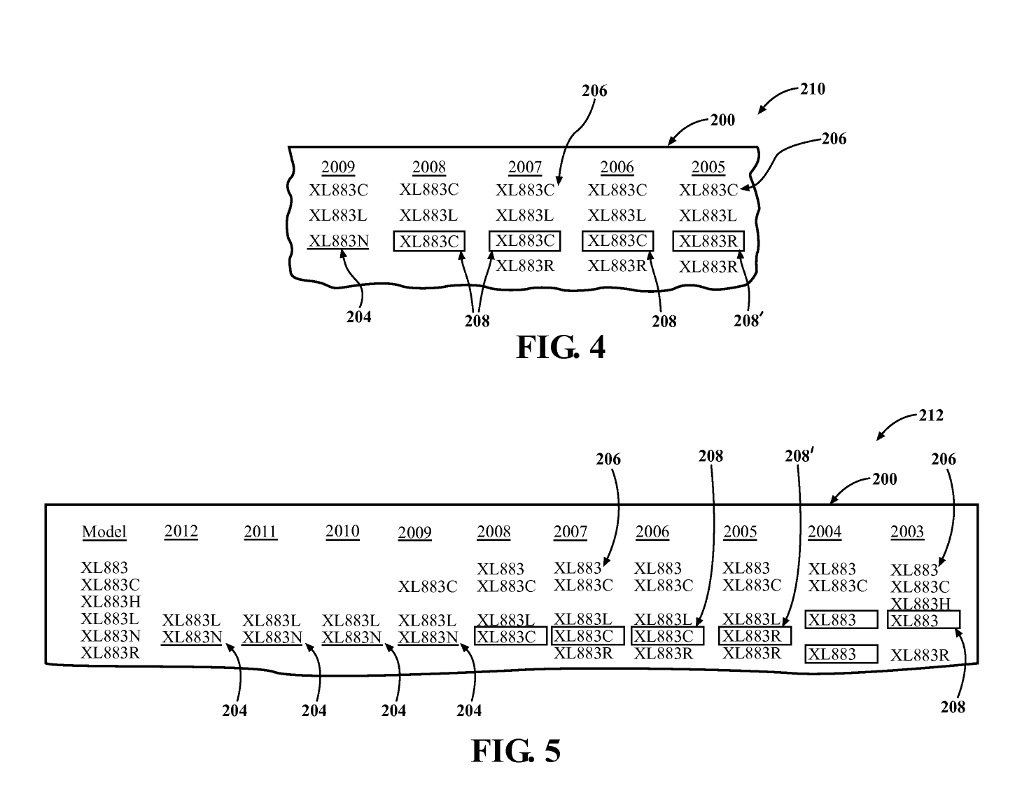

With reference now to FIGS. 1 and 4, the method further comprises the step of populating the initial database 202 with a proxy vehicle identifier 208, 208′ for each first nonexistent model year of the first vehicle to create a comprehensive database 210. The step of populating the initial database 202 with the proxy vehicle identifier 208, 208′ to create the comprehensive database 210 is identified by reference numeral 110 in FIG. 1. The proxy vehicle identifiers 208, 208′ are shown in rectangled font at least in FIG. 4. The proxy vehicles are used as surrogates for the first nonexistent model years of the first vehicle, and the comprehensive database 210 includes the proxy vehicle identifiers 208, 208′ for each of the nonexistent model years of the first vehicle alone.

In an example, the comparing and selecting steps described above may lead to the same proxy vehicle created for each nonexistent model year of the first vehicle. For instance, the selected second vehicle with the unique vehicle identifier 206 of XL883C may be used as the proxy vehicle for each nonexistent model year of the first vehicle with the first vehicle identifier 204 of XL883N. In other instances, however, the comparing and selecting steps may lead to a different proxy vehicles created for the nonexistent model years of the first vehicle. This may occur when there are significant changes in a vehicle model from one year to the next. For instance, and as shown in FIG. 4, the proxy vehicle created for a nonexistent 2006 version of the first vehicle having the vehicle identifier 204 of XL883N is has a proxy vehicle identifier 208 of XL883C. The proxy vehicle identifier 208 of XL883C is the unique vehicle identifier 206 for the selected one of the second vehicles because its attributes are common with attributes of the 2006 version of the first vehicle.

In an example, the method includes populating the initial database 202 with a first proxy vehicle for at least one of the first nonexistent model years, and populating the initial database 202 with a second proxy vehicle for at least one other of the first nonexistent model years with the second proxy vehicle being different from the first proxy vehicle. For instance, and as also shown in FIG. 4, the proxy vehicle created for a nonexistent 2005 version of the first vehicle having the vehicle identifier 204 of XL883N has a proxy vehicle identifier 208′ of XL883R. The proxy vehicle identifier 208′ of XL883R is the unique vehicle identifier 206 for the selected one of the second vehicles which has attributes that are common with attributes of the 2005 version of the first vehicle. As shown in the foregoing examples, the comparing and selecting steps of the method led to a different result with respect to the nonexistent 2005 and 2006 versions of the first vehicle. This result occurred, at least in part, because the 2005 version of the second vehicle with the unique vehicle identifier 206 of XL883C has attributes that are different enough from that of the 2006 version of the second vehicle with the unique vehicle identifier 206 of XL883C to lead to a different result. Accordingly, the 2006 version of the second vehicle with the unique vehicle identifier 206 of XL883C has attributes that are more common with attributes of the first vehicle than any other second vehicle, while the 2005 version of the second vehicle with the unique vehicle identifier 206 of XL883R has attributes that are more common with the attributes of the first vehicle than any other second vehicle. As such, the proxy vehicle created for the nonexistent 2006 version of the first vehicle has a proxy vehicle identifier 208 of XL883C, while the proxy vehicle created for the nonexistent 2005 version of the first vehicle has a proxy vehicle identifier 208′ of XL883R.

In another example, and with reference to FIG. 5, in an example, proxy vehicles may be created for all of the vehicles set forth in the table 200 that have nonexistent model years to create another comprehensive database 212. Each proxy vehicle created for the comprehensive database 212 is identified in table 200 with a proxy vehicle identifier 208, 208′, which is shown in rectangled font in FIG. 5.

It is to be understood that all of the information contained in the comprehensive database 212 up until a then-current year does not change once the comprehensive database 212 is created. However, the comprehensive database 212 can be changed merely to include information for every new or future year. For example, the comprehensive database 212 shown in FIG. 5 may change to include vehicles for 2013, 2014, 2015, and so on, as information for the vehicles during these new years become available.

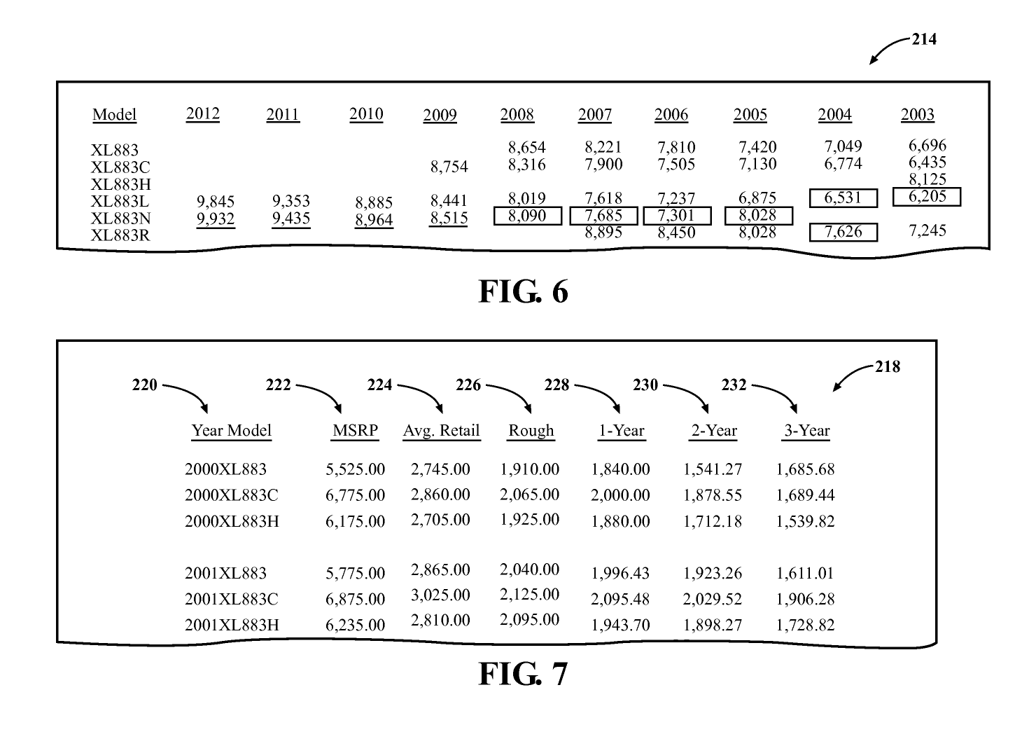

Referring now to FIGS. 1 and 6, the method further comprises converting the proxy vehicle identifier 208, 208′ for each nonexistent model year into a monetary value. The step of converting is identified by reference numeral 112 in FIG. 1. The term “monetary value” describes any value related to money. In one example, the monetary value is an MSRP of the proxy vehicles (i.e., a proxy MSRP). In this example, the step of converting the proxy vehicle identifier includes the steps of obtaining the proxy MSRP for the proxy vehicle for each of the nonexistent model years, and replacing the proxy vehicle identifier with the proxy MSRP. The method further includes the step of creating an MSRP database 216 (shown in FIG. 6) by obtaining a first MSRP for the first vehicle for the existent model years and a unique MSRP for each of the second vehicles for the existent model years, and replacing the first vehicle identifier with the first MSRP and the unique vehicle identifier with the unique MSRP. As shown in FIG. 6, each of the vehicle identifiers 204, 206, 208, 208′ are converted to an MSRP of the vehicle. The step of converting may be accomplished by querying a vehicle pricing guide, such as the NADA guide, for the MSRPs of the vehicles with the vehicle identifiers 204, 206, 208, 208′. Querying may be accomplished, for example, by manually looking up, in a paper or electronic version of the vehicle pricing guide, the MSRP for each of the vehicles with the vehicle identifiers 204, 206, 208, 208′. Alternatively, querying may be accomplished utilizing a wired or wireless connection established between the computer 18 and another computing unit 26 having an electronic version of the vehicle pricing guide 28 resident on the computing unit 26. By executing computer-readable instructions of the application 14, the processor 12 instructs the computing unit 26 to send MSRP data for each of the vehicles with the vehicle identifiers 204, 206, 208, 208′ that are present in the comprehensive database 212. In an example, the proxy MSRP, the first MSRP, and the unique MSRP is obtained by automatically retrieving the proxy MSRP, the first MSRP, and the unique MSRP from an electronic pricing guide (such as the NADA guide). The processor 12 executes computer-readable instructions to automatically remove the replace each of the vehicle identifiers 204, 206, 208, 208′ with the appropriate MSRP to create the MSRP database 214. As shown in the MSRP database in FIG. 6, the MSRP of the first vehicle is shown in underlined font, the MSRP of the second vehicles is shown in regular font, and the MSRP of the proxy vehicles is shown in rectangled font.

In instances where the vehicle identifiers 204, 206, 208, 208′ are automatically converted to MSRPs to create the MSRP database 214 or in instances where the computer 18 is connected to the computing unit 26 with the electronic version of the vehicle pricing guide resident on the computing unit 26, the MSRP database 214 may be automatically updated each time the electronic pricing guide is updated. NADA guides are typically updated every four months, and in one example, the MSRP database 214 is updated every four months. It is to be appreciated that the MSRP database 214 may be updated as often as desired, such as every week, every month, every four months, every six months, every year, etc. In an example, the MSRP database 214 is automatically updated as soon as the vehicle pricing guide is updated. In this example, the computing unit 26 automatically sends the updated MSRP data to the computer 18, and the processor 12 while executing computer-readable instructions of the application 14 automatically replaces the then-current MSRP of the vehicles with the updated MSRP of the vehicles. In another example, the MSRP database 16 is updated upon request by the computer 18 when an update is desired. In this example, the computer 18 queries the computing unit 26 for any updates of the vehicle pricing guide, and if any, the computing unit 26 automatically sends the updated MSRP data to the computer 18. Querying the computing unit 26 for updated MSRP data may be accomplished on command by a user of the computer 18 or automatically according to a user-defined setting, such as every week, every month, every four months, etc.

In an example, the computing unit 26 automatically sorts through the MSRP data in the electronic vehicle pricing guide, and sends only the updated MSRP data associated with the vehicles set forth in the MSRP database 214. In another example, the computing unit 26 sends all of the MSRP data in the updated electronic pricing guide to the computer 18, and the application 14 that is executable by the processor 12 includes computer-readable instructions for sorting through the updated MSRP data, extracting the updated MSRP data needed, and incorporating the updated MSRP data into MSRP database 214.

The method further comprises the step of utilizing the processor 12 to calculate the residual value of the first vehicle utilizing the monetary value of the proxy vehicle. The step of utilizing the processor to calculate the residual value is identified by reference numeral 114 in FIG. 1. In an example, the residual value of the first vehicle is calculated utilizing the application 14, again which is executable by the processor 12. In an example, the step of utilizing the processor to calculate the residual value includes determining a rough book value for each year of the lease period, determining a percentage of the first MSRP retained for each year of the lease period to further define the monetary value, and calculating the residual value for each year of the lease period utilizing the monetary value. The step of determining the rough book value for each year of the lease period includes identifying a year of manufacture of the first vehicle, obtaining a current rough trade-in value for each existent and nonexistent model year of the first vehicle prior to the year of manufacture of the first vehicle within the predetermined time frame, and calculating a percentage between the current rough trade-in values and the first MSRP of the first vehicle to define a rough trade-in percentage for each existent and nonexistent model year of the first vehicle prior to the year of manufacture of the first vehicle within the predetermined time frame. Additionally, the step of determining the percentage of the first MSRP value retained further includes the step of dividing the rough book value for each year of the lease period by the MSRP of the first vehicle.

Examples of the method for calculating of the residual value of the first vehicle are described in detail below.

FIG. 7 depicts a portion of a database 218 comprising some of the vehicles of the comprehensive database 212 in a first column 220 and the MSRP for each of these vehicles in a second column 222. In an example, the method further comprises creating a current retail value database (not shown) which includes the current retail value (i.e., “Avg Retail”) of each of the vehicles set forth in the comprehensive database 212. The current retail value of the vehicles may be obtained from the vehicle pricing guide 28 utilizing any of the methods previously described. The current retail value of the vehicles is incorporated into a third column 224 of the database 218.

In another example, the method further comprises creating a current or present rough trade-in value database (not shown), which includes the current rough trade-in value for each of the vehicles set forth in the comprehensive database 212. The current rough trade-in value of a vehicle is an amount (in terms of money) that a dealer or dealership is willing to pay for the vehicle at that time. FIG. 7 further comprises the rough trade-in value for the vehicles in column 226. Three additional databases (not shown) may also be created for the rough trade-in value of the vehicles for a first year during the lease period, a second year during the lease period, and third year during a lease period. The rough trade-in value for a the first year of the lease period is shown in column 228 in FIG. 7, the rough trade-in value for the second year of the lease period is shown in column 230 in FIG. 7, and the rough trade-in value for the third year of the lease period is shown in column 232 in FIG. 7. The additional database for the first year of the lease period may be created, for example, by determining what the vehicle will be worth 1 year later. For instance, to determine what the rough trade-in value of a 2009 version of the Harley-Davidson® Sportster® XL883C is for a future year (such as for the year 2014 when the then-current year is 2013), the rough trade-in value of a 2008 version of the Harley-Davidson® Sportster® XL883C is divided by the MSRP of the original 2008 version of the Harley-Davidson® Sportster® XL883C. This calculation produces a percentage, which is multiplied by the MSRP of the 2009 version of the Harley-Davidson® Sportster® XL883C. The result gives a rough book value of the 2009 version of the Harley-Davidson® Sportster® XL883C for a 1 year “older” vehicle (i.e., the first year in the lease period which, in this example, is 2014). For example, as shown in FIG. 7, the MSRP of a 2002 version of the Harley-Davidson® Road King® FLHP is $13,982.50. To determine the rough trade-in value of the 2002 version of the Harley-Davidson® Road King® FLHP for a 1 year “older” vehicle (i.e., for the year 2014 when the current year is 2013), the rough trade-in value of a 2001 version of the Harley-Davidson® Road King® FLHP is divided by the MSRP of the 2001 version of the Harley-Davidson® Road King® FLHP. The result of this calculation gives you a percentage. Accordingly, the rough book value of the 2002 version of the Harley-Davidson® Road King®FLHP for a 1 year “older” vehicle (i.e., in 2014) is the previously calculated percentage multiplied by the MSRP of the 2002 version of the Harley-Davidson® Road King® FLHP. Typically, the calculated rough book value of the 2002 version of the Harley-Davidson® Road King® FLHP for a 1 year “older” vehicle (i.e., in 2014) is different from the rough trade-in value of the 2001 version of the same motorcycle.

The rough trade-in value of a vehicle for the second year in a lease period comprises determining what the vehicle will be worth 2 years later. Additionally, the rough trade-in value of a vehicle for the third year in a lease period comprises determining what the vehicle will be worth 3 years later. To determine the rough trade-in value for the second year of the lease period may be determined as follows. To determine what the rough trade-in value of a 2009 version of the Harley-Davidson® Sportster® XL883C is for 2 years in the future (such as for the year 2015 when the then-current year is 2013), the rough trade-in value of a 2007 version of the Harley-Davidson® Sportster® XL883C is divided by the MSRP of the original 2007 version of the Harley-Davidson® Sportster® XL883C. This calculation produces a percentage, which is multiplied by the MSRP of the 2009 version of the Harley-Davidson® Sportster® XL883C. The result gives a rough book value of the 2009 version of the Harley-Davidson® Sportster® XL883C for a 2 year “older” vehicle (i.e., the second year in the lease period, which in this example, is 2015). To determine what the rough trade-in value of a 2009 version of the Harley-Davidson® Sportster® XL883C is for 3 years in the future (such as for the year 2016 when the then-current year is 2013), the rough trade-in value of a 2006 version of the Harley-Davidson® Sportster® XL883C is divided by the MSRP of the original 2006 version of the Harley-Davidson® Sportster® XL883C. This calculation produces a percentage, which is multiplied by the MSRP of the 2009 version of the Harley-Davidson® Sportster® XL883C. The result gives a rough book value of the 2009 version of the Harley-Davidson® Sportster® XL883C for a 3 year “older” vehicle (i.e., in 2016).

The residual value for the first, second, and third years of the lease period may be calculated by dividing each of the rough trade-in values for the first, second, and third years of the lease period by the MSRP of each of the vehicles obtained from the MSRP database 214. These calculations produce new databases that show the percentage (%) of the MSRP retained for the first, second, and third years of the lease period. The percentage of the MSRP retained for the first, second, and third years of the lease period may then be multiplied by the MSRP (again, which is the original manufacturer suggested retail price for the vehicle), and the result of this calculation gives the calculated residual value of the vehicle for the first, second, and third years of the lease period.

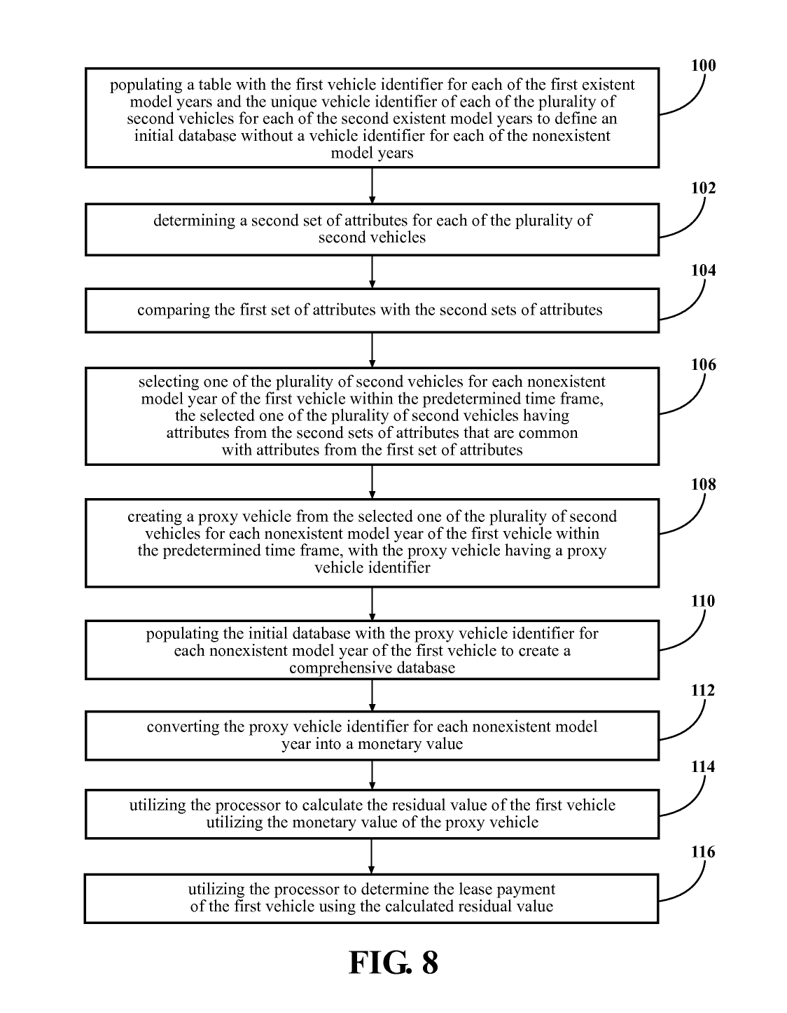

Also disclosed is a method for determining a lease payment of the first vehicle. As shown in FIG. 8, the method includes all of the steps 100 through 114 of FIG. 1 described above for calculating the residual value of the first vehicle. The method further includes the step of utilizing the processor 12 to determine the lease payment of the first vehicle using the calculated residual value. The step of utilizing the processor 12 to determine the lease payment is identified by reference numeral 116 in FIG. 8.

A method for determining the lease payment of the vehicle will now be described in detail. In an example, the method of determining the lease payment includes determining an initial down payment and a monthly payment. This method is described below for a true or “closed end” lease.

The following terms are used through the description for determining the lease payment of the vehicle:

A “dealer sales price” is an agreed upon value of the vehicle which is inclusive of all freight and vehicle preparation charges.

An “up-front sales or use tax” is a tax changed by the dealer's or lessee's state, county, or city. The amount of the tax may be determined by various tax rates and items (such as the vehicle) which is taxable.

“Title, License, and Registration Fees” are the fees charged by a municipality concerned to title and register the vehicle. The Title, License, and Registration fees are typically not taxed.

A “documentation fee” is a fee charged by the dealer for processing the vehicle transaction. In some instances, the documentation fee may be taxed.

An “acquisition fee” is a third party fee for processing the vehicle transaction. In some instances, the acquisition fee may be taxed.

“GAP” is the guaranteed asset protection. Typically, the lessee can purchase coverage that protects the lessee from becoming underwater on a loan should the vehicle be an accident and the insurance carrier does not cover the payoff of the lease. In some instances, GAP protection may be taxed.

“Pre-paid Maintenance” is purchasable by the lessee to cover scheduled vehicle maintenance for a predetermined period of time. In some instances, pre-paid maintenance may be taxed.

An “extended service contract” is purchasable by the lessee to cover repairs not covered by a vehicle warranty for a period of time. In some instances, extended service contracts may be taxed.

The “gross capital cost” is the sum of the dealers sales price, taxes, and all of the other charges and fees mentioned above.

The “net trade-in value” is the value that a dealer is willing to give the lessee upon surrendering his/her present vehicle if any. In some instances, the net trade-in value may reduce the tax basis of the vehicle transaction.

“Rebates” and “Non-cash credits” are dealer credits given to the lessee. In some instances, rebates and non-cash credits may reduce the tax basis of the vehicle transaction.

The “cash down” is the amount of cash put down by the lessee to reduce the gross capital cost, which may reduce the monthly lease payment. The cash down does not include any monthly payments or security deposits due at signing of the lease. Further, the cash down typically does not reduce the tax basis.

The “required minimum down” is the minimum amount of cash for a down payment that is acceptable to a leasing company. The required minimum down may be determined based on the lessee's credit rating or by a leasing company's policy of the amount (in terms of %) over the market value the leasing company is will to pay. Said differently, the required minimum down may be determined by how much the lessor (i.e., the leasing company) is willing to let the dealer markup the transaction or deal over the current market value.

The “capital cost reduction” is the sum of the trade-in value, rebates, and the amount of cash down.

The “adjusted capital cost” is the gross capital cost minus the capital cost reduction. The adjusted capital cost is a value upon which the lease is based and the monthly lease payment is determined.

The “money factor” is a number used in determining the monthly lease payment when using a money factor formula, which is an intended internal rate of return (IRR) divided by the number 24.

The “monthly lease payment” is the monthly payment that the lessee makes during the period of the lease. The monthly lease payment includes up-front taxes (which are capitalized into the gross capital costs) and any taxes on the base monthly payment.

The “dealer reserve/participation” is an addition IRR (in %) that the dealer is allowed to markup the monthly payment if the dealer believes that the lessee is willing to pay more. The dealer may be paid, for example, 70% of the monthly markup times the lease term up front. The total markup is capitalized into the lease.

In an example, the dealers sales price includes the up-front sales or use tax, title, license, and registration fees, documentation fee, acquisition fee, GAP protection, pre-paid maintenance, and extended service contracts. The sum of these fees/costs equals the gross capital cost. The adjusted capital cost is the gross capital cost minus the net trade-in value, minus any rebates/non-cash credits, and the cash down. The adjusted capital cost is the value which determines the basis of the lease.

An example of determining a base monthly lease payment will now be described in detail. The various abbreviations that may be used in the following description include: A which is the adjusted capital cost; R which is the residual value; T which is the lease term (in months); M which is the money factor; P_{b} which is the base monthly lease payment; and P which is the total monthly lease payment. The monthly lease payment may be determined using a money factor methodology which utilizes the sum of a depreciation charge and a finance charge to come up with the monthly lease payment. The depreciation charge D may be determined utilizing Equation 1:

D=(A−R)/T (Eqn. 1)

The finance charge F may be determined utilizing Equation 2:

F=(A+R)×M (Eqn. 2)

The base monthly lease payment may be determined utilizing Equation 3:

P_{b}=D+F

The total monthly lease payment is the base monthly lease payment plus any taxes that may be applicable to the base monthly lease payment. In certain geographic areas (such as in certain states or jurisdictions) that charge a tax based on the base monthly payment, the tax is normally calculated as a percent (%) of the base monthly lease payment. For the purposes of this disclosure, the following abbreviations will be used: iₛ which is the state tax rate; i_{c} which is the tax rate for the relevant geographic area (such as county and city tax rates); I which is the total tax rate where i=iₛ+i_{c}; and I which is the tax on the base monthly lease payment. The tax (I) on the base monthly lease payment may be determined by multiplying the base monthly lease payment and the total tax rate (i). The total monthly lease payment (P) is determined as the base monthly lease payment (P_{b}) plus the monthly tax (I).

The minimum down payment typically arises from criteria set forth by the lessor (i.e., the leasing company). The minimum down payment may be triggered, for example, by the lessee's credit score/tier and/or by the amount the dealer is charging for the vehicle marked up over the market value of the vehicle. A lessee with a lower credit tier often increases a financial risk in any particular lease. This financial risk may be mitigated, for example, by having the lessee put down a down payment which is a required minimum down payment that reduces the financial exposure of the lease and typically compels the lessee to put “some skin in the game” which may make it less likely that he/she will not make the monthly lease payments. The minimum down payment from Tier 5 and below credits is often requested. In an example, the credit tier minimum may be determined by multiplying the credit tier percent down by the dealers sales price.

Additionally, a 115% minimum may also be determined, which generally does not relate to the credit tier. The 115% minimum arises from a desire not to have too much invested in any particular vehicle over an amount that is likely to be recovered in the market. A basis for the 115% calculation is the market value (such as the NADA retail value). The amount to be tested against the 115% of market value is the dealer sales price plus any non-recoverable taxes, charges and fees. In an example, the 115% minimum down payment may be determined by determining the amount to be tested (which is the summation of the dealers sales price, up-front taxes, title, license, and registration fees, and documentation fees) and substracting 115% times the market value. Typically, the final minimum down payment is the greater of the credit tier minimum down or the 115% minimum down.

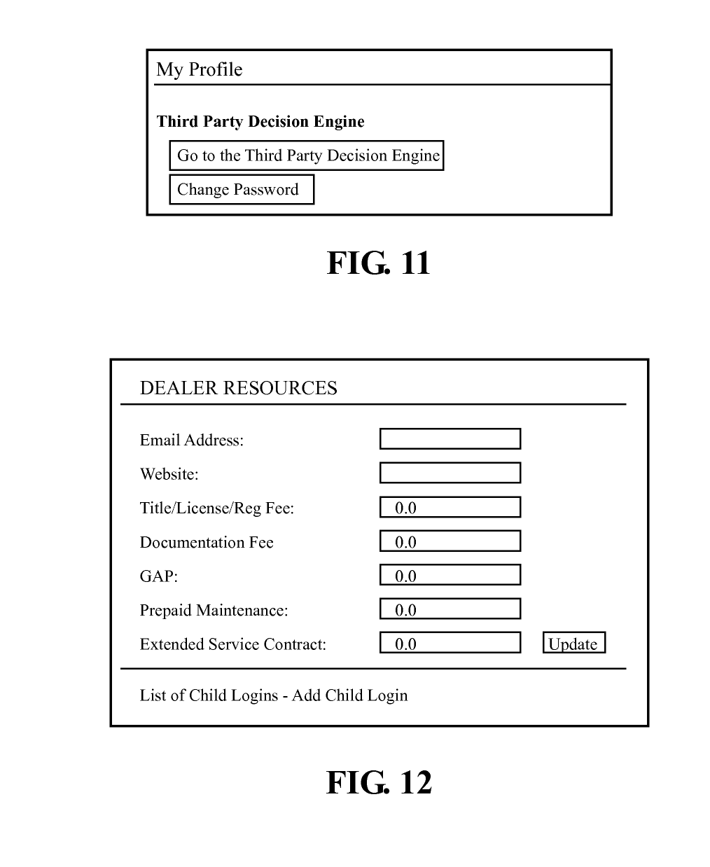

To meet the minimum down payment, the lessee can do a trade-in, a cash down payment, or a combination of both. The web-based application 16, which will be described in detail below with reference to FIGS. 11-20, displays the cash minimum down payment. A trade-in typically reduces that displayed cash minimum. Any additional cash paid beyond that minimum does not affect that minimum. It is to be understood that any additional cash paid may affect up-front taxes, but it typically does not affect the minimum down payment as any additional cash down payment may exceed any tax effect it may have.

A method for estimating a taxation of the vehicle lease is also disclosed. In an example, the method includes generating a tax database (not shown) with a tax rate for a plurality of geographic areas each having a predetermined taxation rule, and automatically estimating the taxation utilizing the tax rate for a selected geographic area and the predefined taxation rule. In an example, the up-front taxes are determined based on the geographic area (such as the state) within which the vehicle transaction is occurring. Typically, each state has its own particular way of computing the up-front tax, which is typically accomplished using one of the following three basic taxation rules or tax regimes: a sales-type tax, a tax on cash changing hands, and a tax of the sum of the payments.

In the sales-type tax regime, typically the state taxes any value transmitted to the lessee. Accordingly, in addition to the price of the vehicle, the tax basis generally includes any documentation fees, acquisition fees, GAP protection costs, service contracts, etc. Title, license, and Registration fees are normally excluded from the tax basis. Furthermore, trade-ins may or may not reduce the tax basis depending on the state. The calculated tax is added to the gross capital costs and is paid up-front by the dealer to the state. In some instances, there may also be tax on the monthly payments.

An example of a sales-type tax calculation includes taking the sum of the dealers sales price, the documentation fees, the acquisition fees, the GAP protection fees, the service contract costs and then subtracting the trade-in value to obtain the tax basis. Assuming a 6% tax rate is used, the tax basis is multiplied by 6% and then added to the amount financed (i.e., capitalized) and the tax would then be paid by the dealer. No further taxes would be due or paid.

In tax on cash changing hands regime, the down payment and the base monthly lease payment are taxed. The tax on the down payment is capitalized and paid up-front by the dealer. The lessor then collects the monthly tax from the total monthly lease payment and remits that tax to the appropriate agency (e.g. to the state). Trade-ins may or may not be considered as a form of down payment, and therefore may or may not be taxable by the state.

An example of a cash changing hands tax calculation includes taking the sum of the down payment and the trade-in value (if any) to determine the tax basis. Assuming a 6% tax rate, the up-front tax would be the tax basis multiplied by 6%, which is added to the gross capital cost and the tax would be paid by the dealer. Assuming that the base monthly lease payment on the amount financed is $300, the monthly tax that would be due is about $18 (6% multiplied by $300), for a total payment of $318. We would remit this $18 to the appropriate agency on the schedule required. In instances where there is a minimum down payment, the tax is divided on the down payment by “1 minus the tax rate” to get a new minimum down payment which includes the taxes. The web-based application 16 also performs this calculation.

In tax on the sum of the payments regime, an up-front tax is calculated by taxing the sum of the monthly payments over the term of the lease and adding the result to the tax on the down payment and, possibly, the tax on any trade-in. This total tax amount is then capitalized and paid up-front by the dealer.

An example of a tax on the sum of the payments calculation includes calculating the amount financed based on the taxable items for a particular geographic area. For instance, the amount financed may be summation of the dealer sales price, the documentation fees, the acquisition fees, the GAP protection fees, and service contracts and subtracting the trade-in cost to obtain an adjusted capital cost. Then, the monthly lease payment is calculated based on the adjusted capital cost. In instances where the monthly lease payment is calculated to be $300, the monthly lease payment is multiplied by the number of months of the lease. If the lease term is 36 months, then $300 times 36 months is $10,800. The $10,800 is then multiplied by the tax rate, such as 6%, which is $648. The amount of $648 is then added to any tax due on the down payment and, in some states the trade-in value. For instance, for a down payment of $3,000 with no trade-in, the tax on the down payment would be $180, and the total tax would be $180 plus $648 or $828. The $828 would be added to the gross capital cost and the tax would be paid by the dealer. The total monthly lease payment would then be based upon this new gross capital cost. It is to be understood that the new total amount financed would include both the taxes calculated above and any non-taxable items previously excluded, such as the title, license and registration fees. Further, no additional taxes would be due or paid.

Accordingly, in view of the three tax regimes described above, the taxes due in a particular geographic area may be determined by determining the basic tax regime that the geographic area is using. The basic items the geographic area includes or excludes is determined for determining the tax basis (for example, most states exclude their own title, license, and registration fees but include the documentation fees and acquisition fees). Further, any peculiarities in the law of the geographic area are determined. For example, in Ohio, any trade-in is deductible from the tax basis if the lease is for a new vehicle, but not if the trade-in is for a used vehicle. In another example, in New Jersey, the lessee can choose to use the lesser of the sales-type regime or the sum-of-the-payments regime for determining the taxation. Additionally, any county and city taxes are included wherever such taxes are required. In an example, the web-based application 16 performs all of these calculations/determinations.

It is to be understood that in addition to the state tax, there may be county and city taxes which are increases in the tax rate. State tax rates tend to stay fixed for years, while county and city rates may change (e.g. quarterly). Further, ZIP codes are not used in determining the tax rates, as any single ZIP code may contain multiple tax jurisdictions

In an example, the 115% minimum calculation under the sum of the payments tax calculation regime may present a challenge not present in the credit tier minimum. The credit tier minimum is fixed as a percent of the dealer sales price and can be accounted for in the sum of the payments tax calculation. While the credit tier minimum may affect the monthly lease payment, and hence that portion of the up-front taxes, the affect is static and typically not dynamic.

The 115% minimum down payment, on the other hand, is typically dynamic, as it affects the monthly lease payment which, in the sum of the payments tax calculation, affects the up-front taxes. This in turn, may affect the 115% down payment, which is a separately taxed item as it is cash, depending on whether or not the trade-in, if any, is a taxable item.

To understand how the 115% minimum affects the up-front tax using the sum of the payments tax calculation regime, one should understand how the monthly lease payment calculation is changed by any change in the 115% minimum down payment. At the outset, any change in the 115% minimum payment typically directly affects the adjusted capital cost (where the adjusted capital cost is the gross capital cost minus the net trade-in value, the rebates/non-cash credits, and the cash down payment. As previously mentioned, the money factor payment calculation may be described by one of the following Equations 3-7:

$$\begin{matrix}P = \frac{( A - R )}{T} + ( A + R ) \cdot M & ( Eqn . 3 ) \\ PT = ( A - R ) + ( A + R ) MT & ( Eqn . 4 ) \\ PT = ( A - R ) + ( AMT + RMT ) & ( Eqn . 5 ) \\ PT = ( A + AMT ) - ( R - RMT ) & ( Eqn . 6 ) \\ P = A ( 1 + MT ) - R ( 1 - MT ) & ( Eqn . 7 )\end{matrix}$$

Looking for the effect that “A” has on “P”, the “R(1−MT)” portion of Equation 7 because “R(1−MT)” is a constant. That leaves the following Equations 8 and 9:

PT=A(1+MT) (Eqn. 8)

P=[A(1+MT)]/T (Eqn. 9)

From this, the relationship between “A” and “P” is (1/T+M). Accordingly, for a 36 month lease for a Tier 7 credit, the result would be ( 1/36+.0125) or 0.040278. Additionally, increasing the down payment reduces A, any increase in the 115% minimum down payment reduces the monthly payments by a factor of −0.040278 in this example.

A change in A typically affects P marginally. Noting that the calculation involves P or P*T, the total change in the sum of the payments tax regime can be expressed by Equation 10:

T(1/T+M) or (1+TM) or about (1+IRR %) (Eqn. 10)

From Equation 10, any absolute change in A caused by the 115% required minimum may engender an absolute change in the sum of the payments tax regime of a similar order or magnitude.

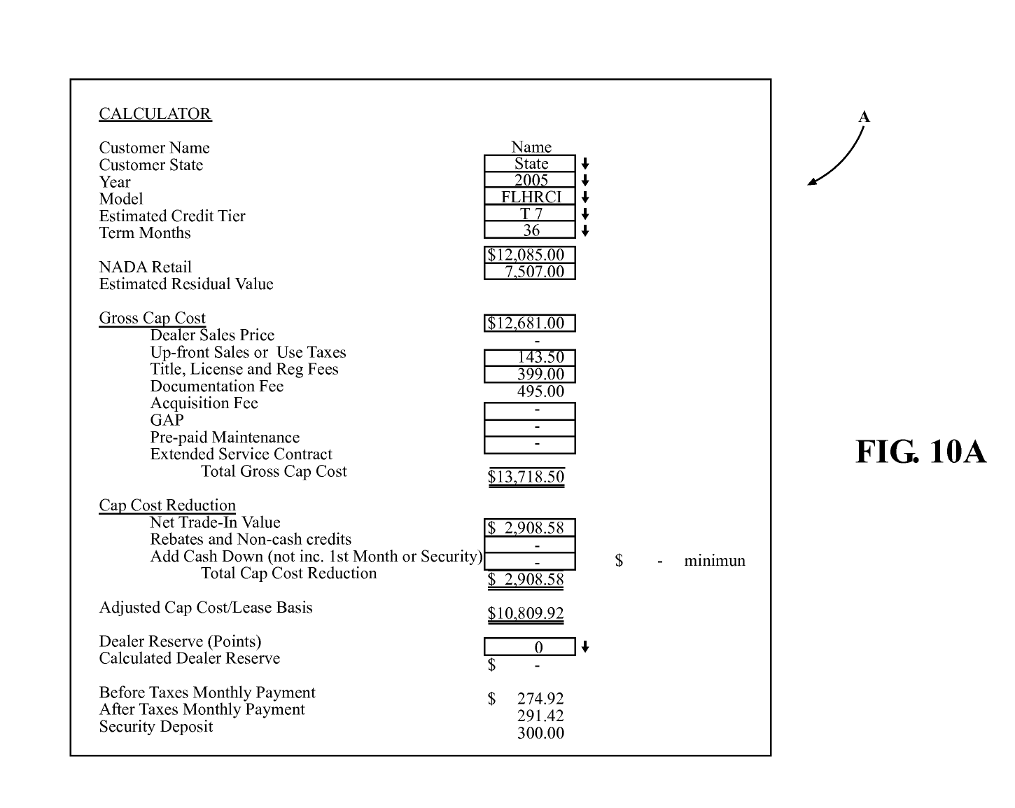

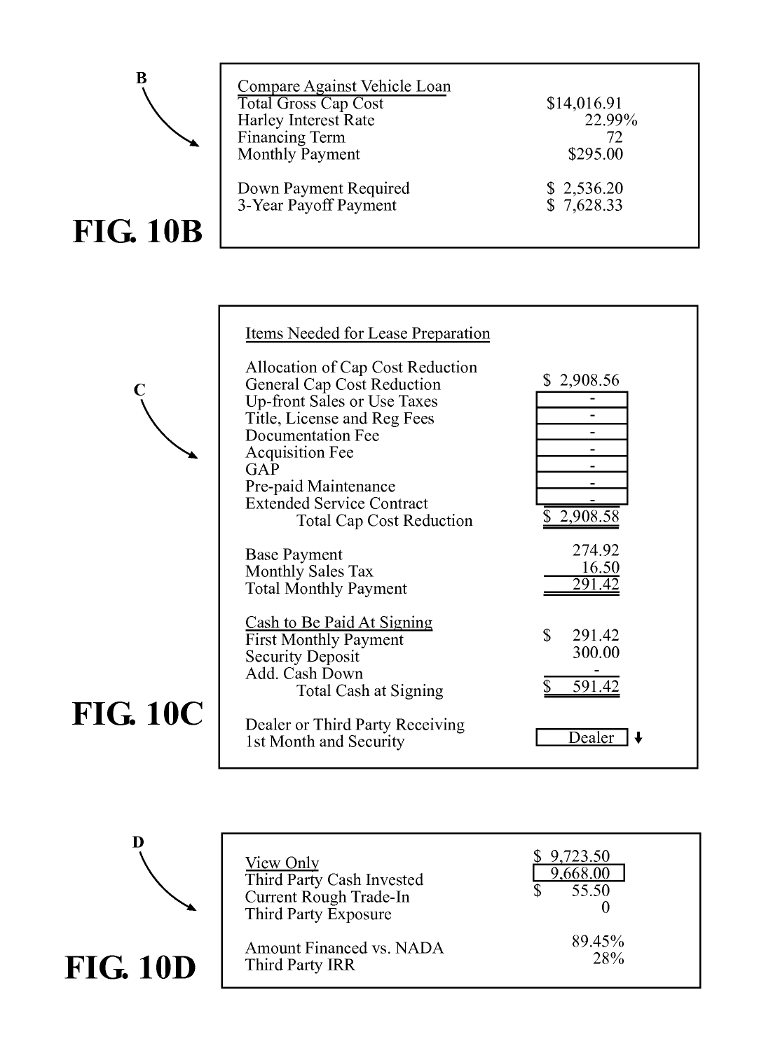

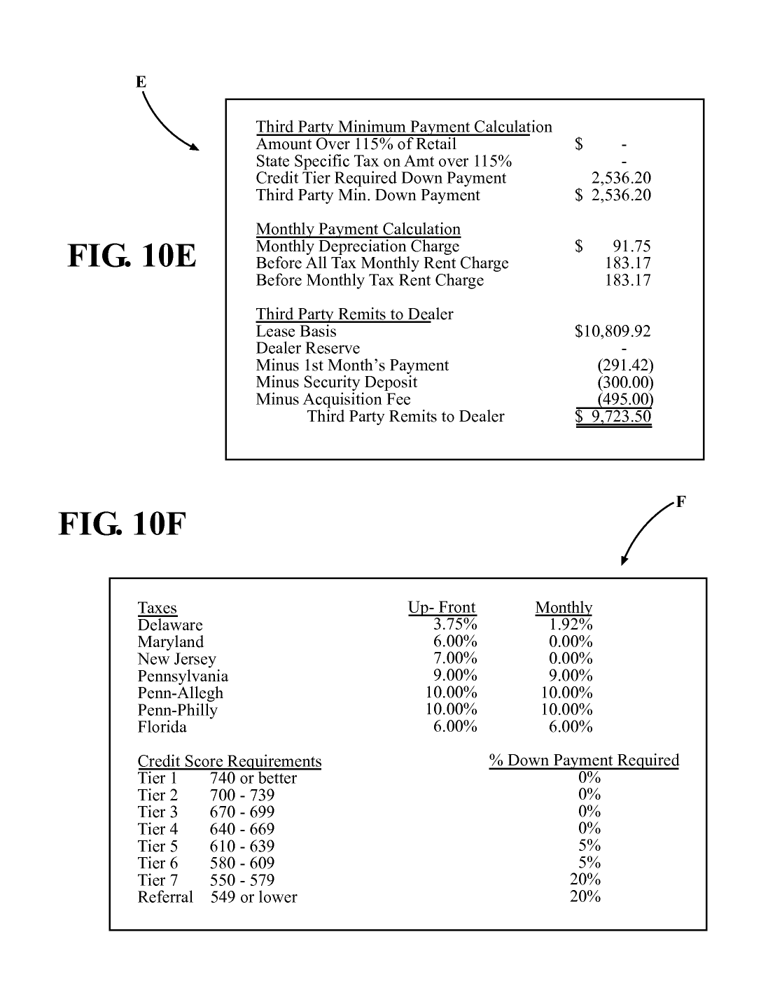

Referring now to FIG. 9, the method for determining the lease payment utilizes the system 10, which includes the computer 18 with the processor 12. The step of utilizing the processor 12 to determine the lease payment of the first vehicle involves utilizing an application 16 which includes computer-readable instructions for determining determine the lease payment of the first vehicle. The application 16 drives a spreadsheet, which is accessible and usable by a user (such as a salesman at a dealership) through a user interface operatively connected to the processor 12. The spreadsheet includes sections A, B, C, D, E, and F set forth in FIGS. 10A, 10B, 10C, 10D, 10E, and 10F, respectively. In this example, each section A-F includes fields where information is either inputted manually or generated by the application 16 utilizing the inputted information. An automated process utilizing the spreadsheet to determine the lease payment of the first vehicle is described below with reference to FIGS. 11-20.

In an example, the application 16 may be downloaded and stored in the storage medium of the computer 18, and the application 16 is accessible and usable through the computer 18. In instances where the computer 18 is connected to a network of computers, all of the computers in the network can access and use the application 16 stored in the computer 18. In another example, the application 16 may be a web-based application. In this example, the application 16 is accessible and usable from any computer or computing device that can establish a connection with the Internet. More specifically, upon establishing a connection with the Internet, the user can access the application 16 by accessing an appropriate webpage. The webpage may be accessible utilizing a suitable Internet browser, such as Firefox®, Internet Explorer™ (such as IE9™), Google Chrome™, or the like. In an example, the Internet browser selected can handle dynamic updating of the web-based application 16.

As a web-based application 16, the user can access the application 16 by accessing the webpage. For dealerships, it may be desirable to save the web-based application 16 as the homepage of the user's (e.g. the saleman's) computer 18. Otherwise, the webpage may be accessed by typing in the proper website (e.g. URL) address in the Internet browser. Upon accessing the webpage, the user can submit an appropriate login and password in order to access and use the webpage to determine a lease payment of a vehicle.

Typically, each authorized person at the dealership (such as all of the salesmen) may have his/her own unique login and password. In some instances, it may be desirable to set up an administrator for the dealership. The administrator may be responsible for managing the application 16 specifically for the dealership, including adding sub-accounts (called Child Logins) and managing default settings of various aspects of the application 16 (e.g. default settings unique to the dealership such as title, registration and documentation fees, and GAP protection, PPM, and ESC costs.

A user-registration process will now be described. In an example, the user may be issued a notification message in the form of an email, a short message service (SMS) message, or the like. This notification message will alert the user to register to use the web-based application 16. Typically, the email includes instructions for registering. The instructions may also describe what the user may need to do during the registration process. The instructions may also include a link to the webpage of the web-based application 16, and the user can access the webpage by clicking on the link. Clicking may be accomplished utilizing a computer mouse, selecting one or more appropriate function keys on a keyboard, or by another suitable method. The user registers by entering his/her login and entering a password. To set the password, the user may be asked to enter the password twice. Afterwards, the user may select an “ACCEPT” or “OK” icon displayed on the webpage to complete the registration process. Once the user has been registered, the user is considered to be logged into the webpage and can use the web-based application 16. It is to be understood that the user registers once, and the user can thereafter access the web-based application 16 by simply accessing the webpage using an Internet browser and entering his/her login and password in the login screen.

After the user has logged into the web-based application 16 through the login screen, the user may be directed to a home page which may provide several icons that are selectable by the user. Examples of the icons include a “MY PROFILE” icon and a “DEALER RESOURCES” icon. Upon selecting the “MY PROFILE” icon, the user can change his/her password or go to another screen, such as a “THIRD PARTY DECISION ENGINE” screen. An example of a “My Profile” screen is shown in FIG. 11. The “THIRD PARTY DECISION ENGINE” screen will be described in further detail below.

Upon selecting the “DEALER RESOURCES” icon, the user can be lead to the “DEALER RESOURCES” screen which is shown in FIG. 12. The “DEALER RESOURCES” screen may be used, by the user, to establish certain standards for the dealership. For instance, if the dealership charges a documentation fee of $195 for every deal (such as a lease) or charges a Title/License/Registration fee of $129, then such information can be entered in the “DEALER RESOURCES” screen. This information may be resident data for any deal that is performed at the dealership.

The “DEALER RESOURCES” screen shown in FIG. 12 further enables the user to edit data entered into the web-based application 16. Typically, the web-based application 16 initially populates appropriate fields of the application 16 if the data is loaded as standard data. For example, pricing for GAP, PPM, and ESC may have been entered, but it may be possible that these features are not sold with every vehicle lease. Accordingly, the user can enter a zero in that field, and the program dynamically adjusts the lease payment calculation based on this data. It is believed that entering the Title/License/Registration fee and Documentation fee as standard values saves time and costs.

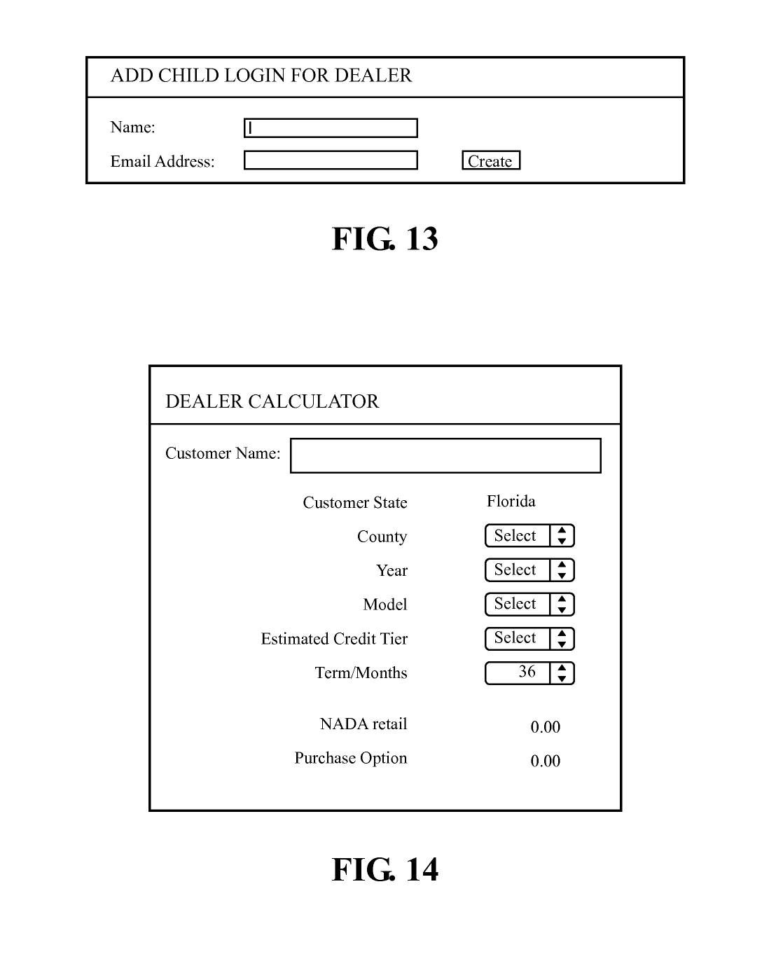

Sub-accounts may also be added for sales managers and/or the like, and these sub-accounts are referred to as Child Logins. Utilizing the application 16, the user may select the “ADD CHILD LOGIN” icon on the homepage which leads the user to the “ADD CHILD LOGIN FOR DEALER” screen, which is shown in FIG. 13. In this screen, the user can enter an appropriate name and email address for the owner of a sub-account (i.e., child account). The sub-account is created upon selecting the “CREATE” icon. The user is then taken back to the homepage of the user's account, and at the bottom of that page, a list of child accounts will be shown. To activate a sub-account, the user can select an icon to register the sub-account, which is located on the screen next to the user's name. An email notification may be sent whenever a sub-account is created with instructions for the owner of the sub-account to register. In an example, a notification that an email has been sent may also be displayed on the webpage. The owner of the sub-account (e.g., a sales manager, a new salesman, etc.) receives the email requesting him/her to register. Registration of the sub-account may be accomplished the same way as the user as previously described. After registration, the owner of the sub-account has access to and can use the web-based application 16. It is noted, however, that the owner of the sub-account may not have access to the administrative components controlled by the administrator.

A “DEALER CALCULATOR” screen is shown in FIG. 14. Further, the information obtained using the “DEALER CALCULATOR” is shown in Section A of the spreadsheet shown in FIG. 10A. In an example, the “DEALER CALCULATOR” may be used to build a deal (e.g. a lease). A deal generally requires i) a customer who wishes to lease a vehicle, ii) a negotiated purchase price of the vehicle, and iii) the customer's credit score or a reasonable guesstimate of the customer's credit score. Other information including the customer name, the customer state, the year and model of the vehicle, the estimated credit tier, and the lease term in months may be entered into the dealer calculator. Almost all of the information to be inputted into Section A of the spreadsheet may be obtained directly from the customer. The estimated credit tier, however, is provided in section F of the spreadsheet shown in FIG. 10F. In an example, the credit tier may be provided in the form of a drop down menu. The user may select the credit tier from the drop down menu that corresponds with the customer's credit score.

The web-based application 16 automatically pulls an MSRP retail value directly from the electronic vehicle pricing guide (such as the NADA guide), and the MSRP retail value is shown in the “DEALER CALCULATOR” shown in FIG. 14. The purchase option is shown as the purchase price, which is also shown on the lease of the motorcycle.

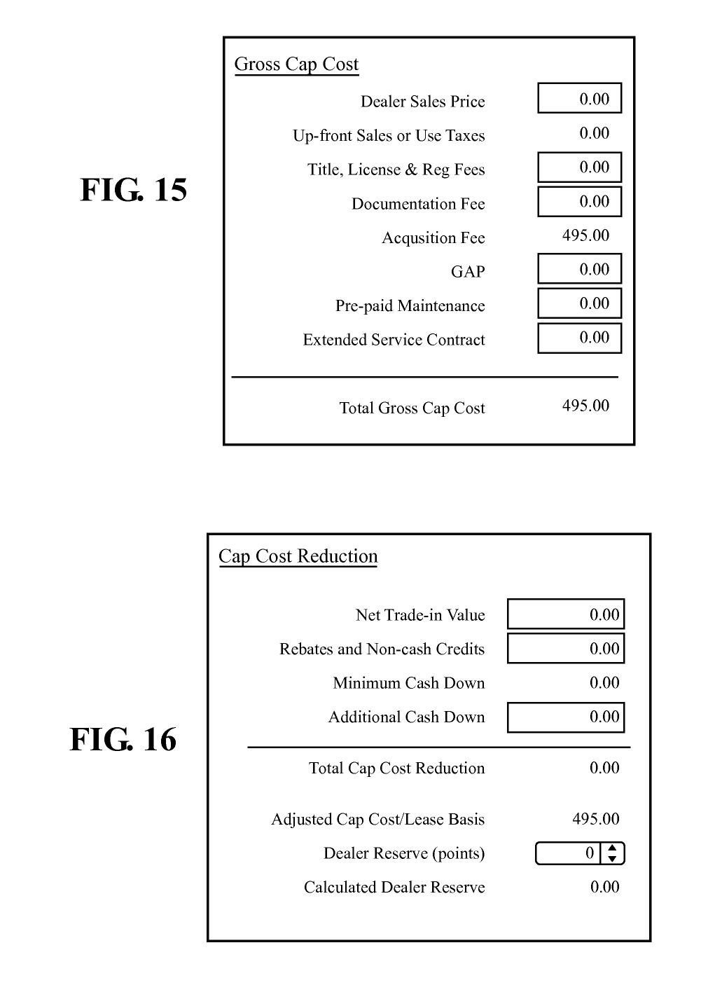

The gross capitalized cost may be calculated utilizing the gross capitalized cost page shown in FIG. 15. On this page, the dealer sales price is the dealership's selling price of the vehicle, which includes dealer vehicle preparation, delivery, freight, and setup fees if any. The up-front taxes are automatically calculated by the application 16, and the Title/License/Registration fees are standard fees that were previously set by the user. Alternatively, the Title/License/Registration fees may be entered manually. The documentation fee may be the standard documentation fee that was previously set by the user, or the documentation fee may be entered manually. It is to be understood, however, that the application 16 may not be able to fund more than 115% of the MSRP retail value against hard costs; i.e., the dealer's sales price, up-front taxes, Title/License/Registration fees, and Documentation fees. To the extent that these amounts exceed 115%, the customer may have to come up with cash or a trade-in. In an example, the amount that the customer comes up with shows up as a minimum cash down.

Other fees include the dealer's acquisition fee and Finance and Insurance (F&I) products including GAP protection, PPM, and ESC. The F&I product values may be entered as defaults by the user (such as the administrator) so that the values appear in every calculation. It is noted that if the values are entered as a default, the values are included as a component of the pricing unless zeroed out manually by the user. In an example, the dealership does not fund GAP, PPM, and ESC values combined in excess of 10% of the MSRP retail value. Exceeding this amount may result in an automatic kick-out of the lease for referral.

The capitalized cost reduction and the adjusted capitalized cost (lease basis) may be calculated as shown in FIG. 16, and is also depicted in Section A of the spreadsheet in FIG. 10A. In instances where there is a trade-in, the net price that is being given by the dealership for the trade-in is entered. The value less the loan payoff is the net trade-in value. Rebates or non-cash credits are also entered here. Also, the minimum cash down is automatically calculated by the program, and is governed by the 115% of the MSRP retail value and any down payment requirements associated with the customer's credit tier. The customer may put down more than a minimum amount in order to reduce his/her monthly payment. The result is the total capital cost reduction.

The adjusted capital cost/lease basis is the result of subtracting the capital cost reduction from the total capital cost. If desired, a dealer may add reserve points in a transaction. In an example, the “VERIFY” icon on the webpage after entering all of the deal values.

It is to be understood that as the deal is built, the application 16 dynamically updates the deal. In instances where the user is requested by the customer to allocate the capital cost reduction funds to specific components of the transaction, the user can be afforded this flexibility. However, this section may be ignored and the capital cost funds may be allocated directly toward the cost of the vehicle.

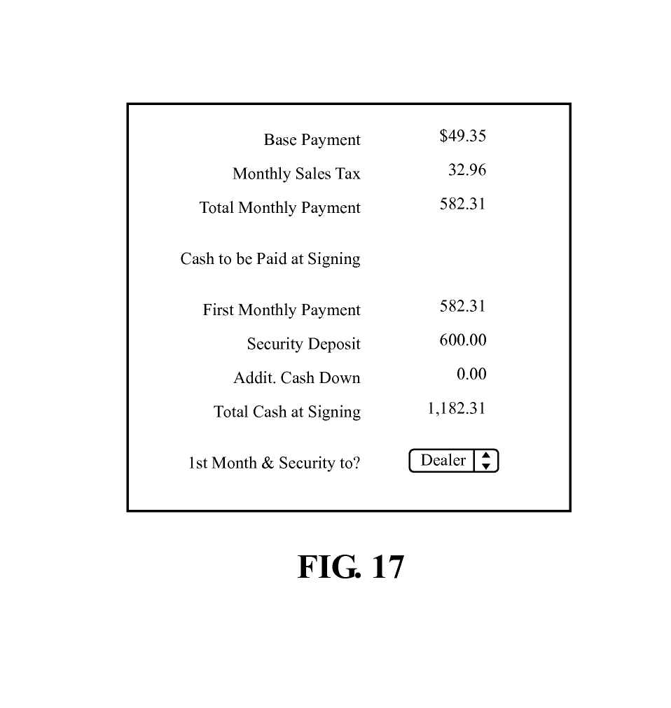

FIG. 17 is an example of a customer in Florida leasing a 2012 Harley-Davidson® model FLHX for a lease term of 36 months. The customer pays the dealership the total cash at signing, and $1,182.31 at closing and completes the lease paperwork. Another example of the cash to be paid at signing is shown in Section C of the spreadsheet depicted in FIG. 10C.

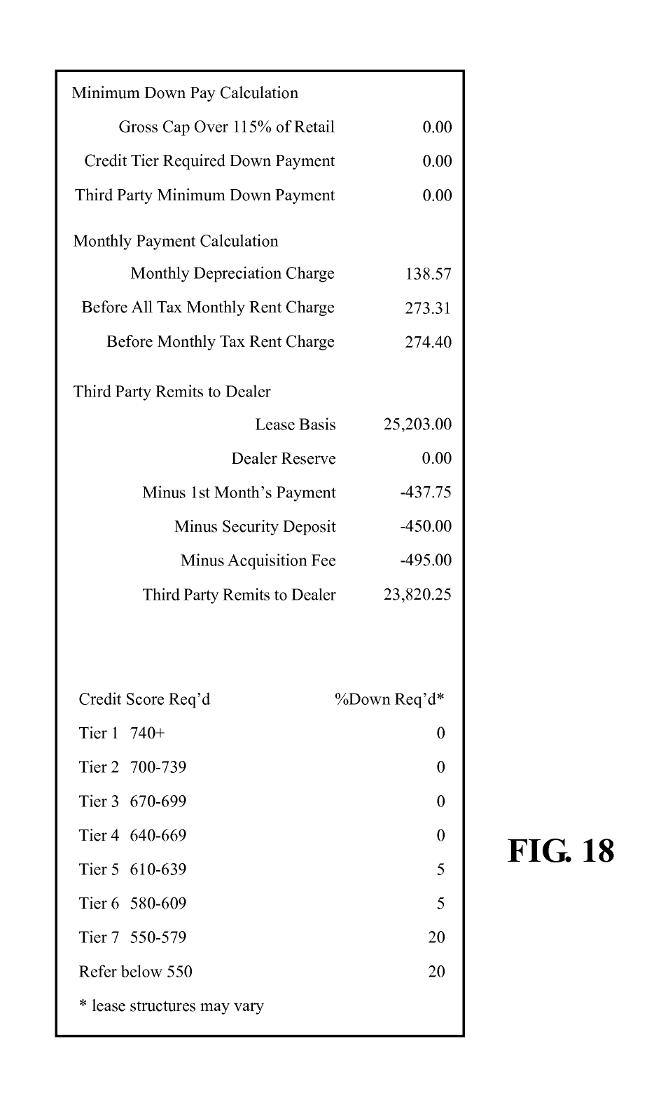

The application 16 includes another calculator which is depicted in FIG. 18. The calculator provides some helpful information including a Tier Guide and the amounts remitted to the dealer when closing out a transaction. The calculator is also shown in Section E of the spreadsheet shown in FIG. 10E.

An approval process may then be performed. The dealer has worked with the customer to define his/her vehicle and to understand his/her budget by the time the customer is ready to lease the vehicle. At this point, credit comes into play, and two situations may be presented; the dealer has the customer's credit score or the credit score is unknown. When the dealer has the customer's credit score, which may have been pulled for another financing product, and such information may be used to place the customer into a proper Credit Tier. The deal data is entered into the webpage, including the credit tier and refining the transaction to suit the customer. An email may be delivered to the leasing company and to the user that is logged into the web-based application 16. The leasing company may respond with a return email with a written approval, an approval with stipulations, or a turn down. Approvals may include a validated lease offer for the customer. Stipulations may be submitted within five days of approval with a copy of a contingent notification.

When the credit score is unknown, the leasing company can pull credit on the customer. An application with the deal data may be submitted by emailing the data from the calculator. The leasing company may respond with a return email with a written approval, an approval with stipulations, or a turn down. Approvals may include a validated lease offer for the customer. Stipulations may be submitted within five days of approval with a copy of the contingent notification.

When the customer agrees with the lease offer and the leasing company has approved the application, a documentation process is initiated. Information such as the identity of the customer, the VIN, color, and mileage of the vehicle, as well as the year, make, and model of the vehicle are provided. Also provided is the term of any F&I products. The leasing company may email a fully completed, signature-ready lease pack to the user and/or the customer. The pack may include a signature instruction sheet, a state-specific lease agreement, an Automated Clearing House (ACH) form, the lease application, condition report, odometer statement, title application, and funding checklist. The lease pack can be printed on standard 8.5″×11″ paper, and the vehicle may be walked with the customer to complete the condition report. The customer signs all of the documents where indicated, and the dealer signs where indicated. The dealer may review the funding checklist, and when it is complete, may overnight the completed package to the leasing company. The leasing company may fund immediately upon successful review of the completed documentation package.

The insurance for the vehicle is determined as follows. Certain endorsements may be required, which may include insurance coverage. In an example, verification of insurance coverage is required, and is to meet the following standards: $100 k/$300 k/$50 k Limits of Liability, and Comprehensive coverage with a maximum deductible of $500 Collision coverage with a maximum deductible of $500. The customer typically finds the best coverage at the carrier of his/her choice.

Further, title applications may be handled with State Specific formatting. The leasing company provides signature-ready, Sate Specific Lease Packs for each transaction. The appropriate title applications are typically print ready for the title clerk's submittal.

For new vehicle leases, and to receive explicit delivery and warranty registration instructions, each dealership sends a letter requesting the leasing company be approved as a valid leasing entity. The letter includes a copy of the leasing company's certificate of registration to conduct business in the state where the dealership facility is located. To be fully compliant with the non-retail sales policy, the vehicle may be delivered to the customer at the dealership facility, and the registration may contain both the lease company and the customer's name.

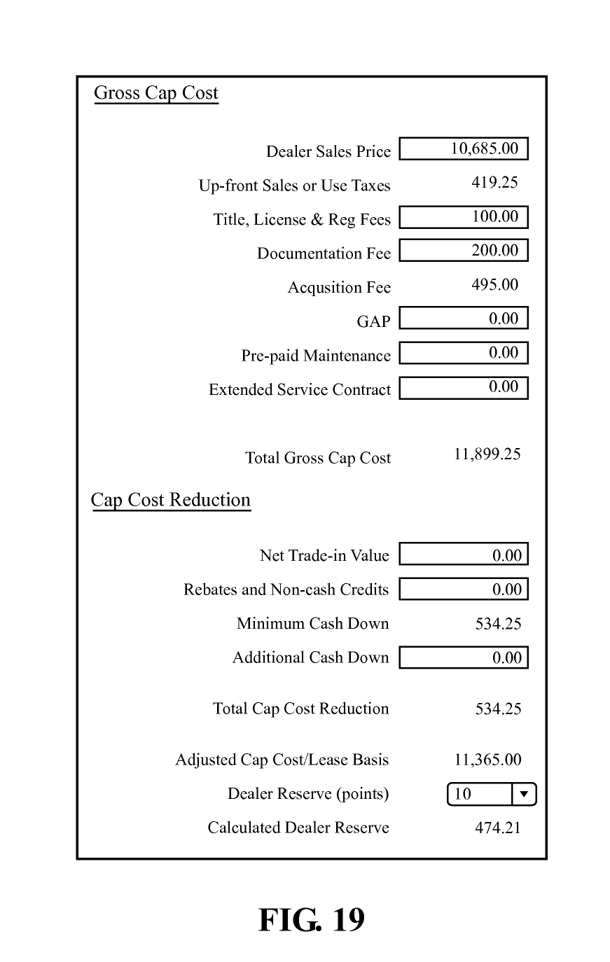

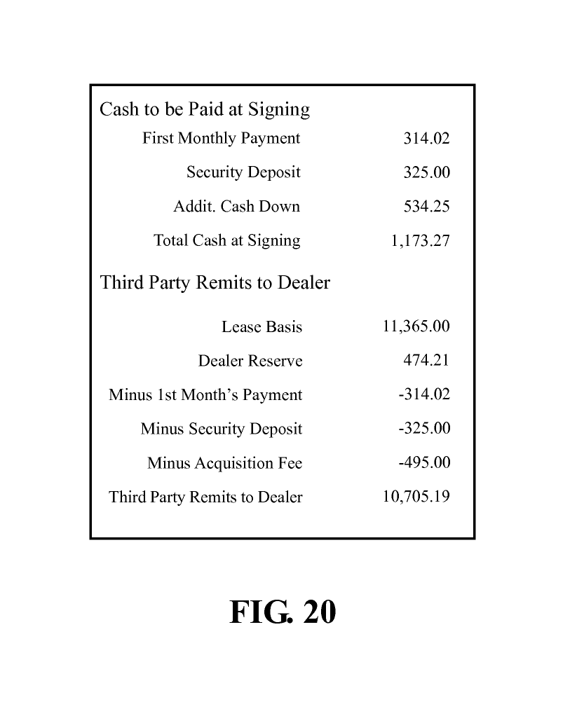

A lease transaction may be entered into the program as shown in FIG. 19. In an example, data to be entered into a deal are contained in the gross capitalized cost and the capitalized cost reduction calculators. The information to be entered includes the sales price (including dealer prep, delivery, freight, and setup if applicable), up-front tax (if applicable), title and license fees, documentation fee (if applicable), GAP, pre-paid maintenance, and/or extended service contract (if applicable), net trade allowance (if applicable), and dealer reserve (if applicable). After collecting the customer's first payment, security deposit, and additional cash down, the COD on the deal is equal to the amount that the leasing company remits to the dealership. This is shown in FIG. 20.

In an example, the method for determining the lease payment further comprises estimating a taxation of the lease payment of the first vehicle. Estimation of the taxation may be accomplished by generating a tax database with a tax rate for a plurality of geographic areas each having a predefined taxation rule. The method generates a plurality of taxation rules that follow the geographic area taxing schemes set forth above. The taxation rules are used in combination with an appropriate tax rate to determine an appropriate taxation of the lease payment. The method of determining the lease payment may then be accomplished utilizing the calculated residual value and the estimated taxation.

The methods for calculating the residual value of the first vehicle and for determining a lease payment of the first vehicle has been described above as being performed by a processor 12 executing the applications 14, 16. It is to be understood, however, that the method for calculating the residual value may be performed using a first processor, while the method for determining the lease payment may be performing using a second processor. In this example, the first and second processors are in operative communication with one another, and the first processor submits the calculated residual value to the second processor for the lease payment determination.

The disclosure includes description in an illustrative manner, and it is to be understood that the terminology which has been used is intended to be in the nature of words of description rather than of limitation. It is now apparent to those skilled in the art that many modifications and variations of the present disclosure are possible in light of the above teachings. It is, therefore, to be understood that the disclosure may be practiced otherwise than as specifically described.

What is claimed is:

1. A method for forecasting a residual value of a first vehicle having first existent model years and first nonexistent model years with the first existent model years and the first nonexistent model years falling within a predetermined time frame, and the first vehicle further having a first vehicle identifier and a first set of attributes, said method utilizing a plurality of second vehicles having second existent model years and second nonexistent model years with each of the second vehicles having a unique vehicle identifier, with one or more steps of said method being implemented by a processor having a non-transitory computer-readable storage medium with an executable application stored thereon, and said method comprising the steps of:
populating a table with the first vehicle identifier for each of the first existent model years and the unique vehicle identifier of each of the plurality of second vehicles for each of the second existent model years to define an initial database without a vehicle identifier for each of the nonexistent model years;
determining a second set of attributes for each of the plurality of second vehicles;
comparing the first set of attributes with the second sets of attributes;
selecting one of the plurality of second vehicles for each nonexistent model year of the first vehicle within the predetermined time frame, the selected one of the plurality of second vehicles having attributes from the second sets of attributes that are common with attributes from the first set of attributes;
creating a proxy vehicle from the selected one of the plurality of second vehicles for each first nonexistent model year within the predetermined time frame, with the proxy vehicle having a proxy vehicle identifier;
populating the initial database with the proxy vehicle identifier for each first nonexistent model year to create a comprehensive database;
converting the proxy vehicle identifier for each first nonexistent model year into a monetary value; and
utilizing the processor to calculate the residual value of the first vehicle utilizing the monetary value of the proxy vehicle.

2. The method as set forth in claim 1 wherein the step of determining the second set of attributes is further defined as determining at least one of physical characteristics of each of the second vehicles, performance characteristics of each of the second vehicles, historical retail value data of each of the second vehicles, popularity of each of the second vehicles, and availability of each of the second vehicles.

3. The method as set forth in claim 1 wherein prior to comparing the first set of attributes with the second set of attributes, the method further comprises the steps of:
identifying the first vehicle as being a member of a first family of vehicles; and
narrowing the plurality of second vehicles to the second vehicles that fall within one of the first family of vehicles or a second family of vehicles that is financially or physically related to the first family of vehicles.

4. The method as set forth in claim 1 wherein the monetary value is a proxy manufacturer suggest retail price (MSRP), and wherein the step of converting the proxy vehicle identifier further includes the steps of:
obtaining the proxy MSRP for the proxy vehicle for each of the nonexistent model years; and
replacing the proxy vehicle identifier with the proxy MSRP.

5. The method as set forth in claim 4 further comprising the step of creating an MSRP database which comprises the steps of:
obtaining a first MSRP for the first vehicle for the existent model years and a unique MSRP for each of the second vehicles for the existent model years;
replacing the first vehicle identifier with the first MSRP and the unique vehicle identifier with the unique MSRP.

6. The method as set forth in claim 5 wherein the steps of obtaining the proxy MSRP and obtaining the first MSRP and the unique MSRP further includes the step of automatically retrieving the first MSRP, the unique MSRP, and the proxy MSRP from an electronic vehicle pricing guide.

7. The method as set forth in claim 5 wherein the first vehicle includes a lease period and the step of utilizing the processor to calculate the residual value of the first vehicle further includes the steps of:
determining a rough book value for each year of the lease period;
determining a percentage of the first MSRP retained for each year of the lease period to further define the monetary value; and
calculating the residual value for each year of the lease period utilizing the monetary value.

8. The method as set forth in claim 7 wherein the step of determining the rough book value for each year of the lease period further includes the steps of:
identifying a year of manufacture of the first vehicle;
obtaining a current rough trade-in value for each existent and nonexistent model year of the first vehicle prior to the year of manufacture of the first vehicle within the predetermined time frame; and
calculating a percentage between the current rough trade-in values and the first MSRP of the first vehicle to define a rough trade-in percentage for each existent and nonexistent model year of the first vehicle prior to the year of manufacture of the first vehicle within the predetermined time frame.

9. The method as set forth in claim 7 wherein the step of determining the percentage of the first MSRP value retained further includes the steps of dividing the rough book value for each year of the lease period by the MSRP of first vehicle.

10. A method of determining a lease payment of a first vehicle having first existent model years and first nonexistent model years with the first existent model years and the first nonexistent model years falling within a predetermined time frame, and the first vehicle further having a first vehicle identifier and a first set of attributes, said method identifying a plurality of second vehicles having second existent model years and second nonexistent model years with each of the second vehicles having a unique vehicle identifier, with one or more steps of said method being implemented by a processor having a non-transitory computer-readable storage medium with an executable application stored thereon, and said method comprising the steps of:
populating a database with the first vehicle identifier for each of the first existent model years and the unique vehicle identifier of each of the plurality of second vehicles for each of the second existent model years to define an initial database without a vehicle identifier for each of the nonexistent model years;
determining a second set of attributes for each of the plurality of second vehicles;
comparing the first set of attributes with the second sets of attributes;
selecting one of the plurality of second vehicles for each nonexistent model year of the first vehicle within the predetermined time frame, the selected one of the plurality of second vehicles having attributes from the second sets of attributes that are common with attributes from the first set of attributes;
creating a proxy vehicle from the selected one of the plurality of second vehicles for each nonexistent model year of the first vehicle within the predetermined time frame, with the proxy vehicle having a proxy vehicle identifier;
populating the initial database with the proxy vehicle identifier for each first nonexistent model year to create a comprehensive database;
converting the proxy vehicle identifier for each first nonexistent model year into a monetary value; and
utilizing the processor to calculate the residual value of the first vehicle utilizing the monetary value of the proxy vehicle; and
utilizing the processor to determine the lease payment of the first vehicle using the calculated residual value.

11. The method as set forth in claim 10 wherein the first vehicle has a year of manufacture and further includes the steps of:
identifying a lease term of the first vehicle; and
selecting a number of years prior to the year of manufacture of the first vehicle and a number of years subsequent to the year of manufacture of the first vehicle up to the end of the lease term to further define the predetermined time frame.

12. The method as set forth in claim 10 wherein the step of populating the initial database with the proxy vehicle identifier further includes the steps of:
populating the initial database with a first proxy vehicle for at least one of the first nonexistent model years; and
populating the initial database with a second proxy vehicle for at least one other of the first nonexistent model years with the second proxy vehicle being different from the first proxy vehicle.

13. The method as set forth in claim 10 further comprising the method step of estimating a taxation of the lease payment of the first vehicle that further includes the steps of:
generating a tax database with a tax rate for a plurality of geographic areas each having a predefined taxation rule; and
automatically estimating the taxation utilizing the tax rate for a selected geographic area and the predefined taxation rule.

14. The method as set forth in claim 13 wherein the step of determining the lease payment of the first vehicle is further defined as determining the lease payment utilizing the calculated residual value and the estimated taxation.

15. The method as set forth in claim 10 wherein the step of utilizing the processor to determine the lease payment of the first vehicle is further defined as determining the lease payment utilizing the calculated residual value and a credit score of a customer.

16. A system for determining a lease payment of a first vehicle having first existent model years and first nonexistent model years with said first existent model years and said first nonexistent model years falling within a predetermined time frame, and said first vehicle further having a first vehicle identifier and a first set of attributes, said system identifying a plurality of second vehicles having second existent model years and second nonexistent model years with each of said second vehicles having a unique vehicle identifier and a second set of attributes, said system comprising:
an initial database comprising said first vehicle identifier for each of said first existent model years and said unique vehicle identifier of each of said plurality of second vehicles for each of said second existent model years with said initial database being without a vehicle identifier for each of said first and second nonexistent model years;
a comprehensive database comprising said initial database populated with a proxy vehicle identifier for said nonexistent model years of said first vehicle within said predetermined time frame with said proxy vehicle identifier identifying a proxy vehicle from a selected one of said plurality of second vehicles having attributes from said second set of attributes that are common with attributes from said first set of attributes;
a computer comprising a processor and a storage medium with said initial database and said comprehensive database stored in said storage medium;
a first application executable by said processor and comprising computer-readable instructions for converting said proxy vehicle identifier for each first nonexistent model year into a monetary value; and
a second application executable by said processor and comprising computer-readable instructions for determining said lease payment of said first vehicle utilizing said monetary value.

17. The system as set forth in claim 16 wherein said second application further comprises computer-readable instructions for estimating a taxation of said lease payment of said first vehicle.

18. The system as set forth in claim 17 wherein said computer-readable instructions for determining said lease payment comprises computer-readable instructions for:
generating a tax database comprising a tax rate for a plurality of geographic areas each having a predefined taxation rule; and
automatically estimating said taxation utilizing said tax rate for a selected one of said plurality of geographic areas and said predefined taxation rule.

19. The system as set forth in claim 17 wherein said second application further comprises computer-readable instructions for determining said lease payment utilizing said calculated residual value and said estimated taxation.

20. The system as set forth in claim 16 wherein said processor further comprises computer-readable instructions for determining said lease payment utilizing said calculated residual value and a credit score of a lessee.

21. The system as set forth in claim 16 wherein said first set of attributes comprises physical characteristics of said first vehicle, performance characteristics of said first vehicle, historical retail value data of said first vehicle, popularity of said first vehicle, availability of said first vehicle, and combinations thereof, and wherein said second set of attributes comprises physical characteristics of each of said second vehicles, performance characteristics of each of said second vehicles, historical retail value data of each of said second vehicles, a popularity of each of said second vehicles, an availability of each of said second vehicles, and combinations thereof.
